(19) United States
(12) Patent Application Publication
(10) Pub. No.: US 2016/0358264 A1
(43) Pub. Date: Dec. 8, 2016

(54) EQUITY INCOME INDEX CONSTRUCTION TRANSFORMATION SYSTEM, METHOD AND COMPUTER PROGRAM PRODUCT

(71) Applicant: Research Affiliates, LLC, Newport Beach, CA (US)

(72) Inventors: Christopher J. Brightman, Newport Beach, CA (US); Jason Hsu, Newport Beach, CA (US); Vitali Kalesnik, Newport Beach, CA (US); Feifei Li, Newport Beach, CA (US); Robert D. Arnott, Newport Beach, CA (US)

(73) Assignee: Research Affiliates, LLC, Newport Beach, CA (US)

(21) Appl. No.: 15/229,129

(22) Filed: Aug. 5, 2016

Related U.S. Application Data
(63) Continuation-in-part of application No. 13/844,478, filed on Mar. 15, 2013.
Application No. 13/844,478 is a continuation-in-part of application No. 13/216,238, filed on Aug. 23, 2011, now Pat. No. 8,589,276.
Application No. 13/216,238 is a continuation-in-part of application No. 12/619,668, filed on Nov. 16, 2009, now Pat. No. 8,374,937.
Application No. 12/619,668 is a continuation-in-part of application No. 11/931,913, filed on Oct. 31, 2007, now Pat. No. 8,005,740.
Application No. 11/931,913 is a continuation-in-part of application No. 11/509,002, filed on Aug. 24, 2006, now Pat. No. 7,747,502.
Application No. 11/509,002 is a continuation-in-part of application No. 11/196,509, filed on Aug. 4, 2005, now Pat. No. 7,620,577.
Application No. 11/196,509 is a continuation-in-part of application No. 10/961,404, filed on Oct. 12, 2004, now Pat. No. 7,792,719.
(60) Provisional application No. 62/201,560, filed on Aug. 5, 2015.
(60) Provisional application No. 60/896,867, filed on Mar. 23, 2007.
(60) Provisional application No. 60/751,212, filed on Dec. 19, 2005.
(60) Provisional application No. 60/541,733, filed on Feb. 4, 2004.

(51) Int. Cl. G06Q 40/06; G06Q 40/02; G06Q 40/04

(52) U.S. Cl. CPC G06Q 40/06; G06Q 40/04; G06Q 40/02

(57) ABSTRACT

A computer data processing system, method and/or computer program product can include a memory coupled to the special purpose processor, the processor configured to: receive electronically, by a special purpose index calculator computer device processor, a universe of publicly traded companies; receive electronically from an electronic data source a plurality of metrics relating to the publicly traded companies, comprising: corporate action data, price data, foreign exchange data, and fundamental financial metric data; combine the plurality of metrics to calculate: a robustness ranking; a dividend yield percentile ranking; and a noncapitalization weighting for the publicly traded companies use the combined metric data to at least one of: a) electronically select or weight constituents of an index based on the combined data; b) electronically select or weight a portfolio of financial objects based on the combined data; or c) electronically allocate assets in a portfolio based on the combined data.

### CROSS-REFERENCE TO RELATED APPLICATIONS

The present application is a nonprovisional, continuation-in-part, and claims the benefit under 35 U.S.C. §119 (e) of U.S. Patent Application Ser. No. 62/201,560 filed Aug. 5, 2015, and is a continuation-in-part of and claims priority to under 35 U.S.C. §120 of copending U.S. patent application Ser. No. 13/844,478, filed Mar. 15, 2013, which claims priority to U.S. patent application Ser. No. 13/216,238, filed Aug. 23, 2011, which is a continuation-in-part of U.S. patent application Ser. No. 11/931,913, filed Oct. 31, 2007, now U.S. Pat. No. 8,005,740, issued Aug. 23, 2011, which is a continuation-in-part of and claims the benefit of U.S. Patent Application No. 60/896,867, filed Mar. 23, 2007, the contents of all of which are incorporated herein by reference in their entirety and are of common assignee.

U.S. patent application Ser. No. 11/931,913 is also a continuation-in-part of and also claims the benefit of U.S. patent application Ser. No. 11/509,002, filed Aug. 24, 2006, the contents of which are incorporated herein by reference in their entirety and are of common assignee, which claims the benefit of (i) U.S. Patent Application No. 60/751,212, filed Dec. 19, 2005, the contents of which are incorporated herein by reference in their entirety and are of common assignee, and (ii) U.S. patent application Ser. No. 11/196,509, filed Aug. 4, 2005, the contents of which are incorporated herein by reference in their entirety and are of common assignee, which claims the benefit (a) of U.S. patent application Ser. No. 10/159,610, filed Jun. 3, 2002, the contents of which are incorporated herein by reference in their entirety and are of common assignee, and (b) U.S. patent application Ser. No. 10/961,404, filed Oct. 12, 2004, the contents of which are incorporated herein by reference in their entirety and are of common assignee, which in turn claims the benefit of U.S. Patent Application No. 60/541,733, filed Feb. 4, 2004, the contents of which are incorporated herein by reference in their entirety and are of common assignee. The present application is also related to U.S. patent application Ser. No. 12/619,668, filed November 16, 2009; U.S. patent application Ser. No. 12/554,961, filed September 7, 2009; U.S. patent application Ser. No. 12/752,159, filed Apr. 1, 2010; and U.S. patent application Ser. No. 12/819,199, filed Jun. 19, 2010; the contents of all of which are incorporated herein by reference in their entirety and are of common assignee.

### BACKGROUND OF THE DISCLOSURE

1. Field of the Disclosure

Exemplary embodiments relate generally to automated computer systems executing instructions relating to securities investing, and more particularly to automated computer systems executing instructions relating to construction and use of indexes and data indicative of portfolios based on indexes.

2. Related Background of the Disclosure

Conventionally, there are various broad categories of securities portfolio management. One conventional securities portfolio management category is active management wherein the securities are selected for a portfolio individually based on economic, financial, credit, and/or business analysis; on technical trends; on cyclical patterns; etc. Another conventional category is passive management, also called indexing, wherein the securities in a portfolio duplicate those that make up an index. The securities in a passively managed portfolio are conventionally weighted by relative market capitalization weighting or equal weighting. Another middle ground conventional category of securities portfolio management is called enhanced indexing, in which a portfolio's characteristics, performance and holdings are substantially dominated by the characteristics, performance and holdings of the index, albeit with modest active management departures from the index.

The present invention relates generally to the passive and enhanced indexing categories of portfolio management. A securities market index, by intent, reflects an entire market or a segment of a market. A passive portfolio based on an index may also reflect the entire market or segment. Often every security in an index is held in the passive portfolio. Sometimes statistical modeling is used to create a portfolio that duplicates the profile, risk characteristics, performance characteristics, and securities weightings of an index, without actually owning every security included in the index. (Examples could be portfolios based on the Wilshire 5000 Equity Index or on the Lehman Aggregate Bond Index.) Sometimes statistical modeling is used to create the index itself such that it duplicates the profile, risk characteristics, performance characteristics, and securities weightings of an entire class of securities. (The Lehman Aggregate Bond Index is an example of this practice.)

Indexes are generally all-inclusive of the securities within their defined markets or market segments. In most cases indexes may include each security in the proportion that its market capitalization bears to the total market capitalization of all of the included securities. The only common exceptions to market capitalization weighting are equal weighting of the included securities (for example the Value Line index or the Standard & Poors 500 Equal Weighted Stock Index, which includes all of the stocks in the S&P 500 on a list basis; each stock given equal weighting as of a designated day each year) and share price weighting, in which share prices are simply added together and divided by some simple divisor (for example, the Dow Jones Industrial Average). Conventionally, passive portfolios are built based on an index weighted using one of market capitalization weighting, equal weighting, and share price weighting.

Most commonly used stock market indices are constructed using a methodology that is based upon either the relative share prices of a sample of companies (such as the Dow Jones Industrial Average) or the relative market capitalization of a sample of companies (such as the S&P 500 Index or the FTSE 100 Index). The nature of the construction of both of these types of indices means that if the price or the market capitalization of one company rises relative to its peers it is accorded a larger weighting in the index. Alternatively, a company whose share price or market capitalization declines relative to the other companies in the index is accorded a smaller index weighting. This can create a situation where the index, index funds, or investors who desire their funds to closely track an index, are compelled to have a higher weighting in companies whose share prices or market capitalizations have already risen and a lower weighting in companies that have seen a decline in their share price or market capitalization.

Advantages of passive investing include: a low trading cost of maintaining a portfolio that has turnover only when an index is reconstituted, typically once a year; a low management cost of a portfolio that requires no analysis of individual securities; and/or no chance of the portfolio suffering a loss--relative to the market or market segment the index reflects--because of misjudgments in individual securities selection.

Advantages of using market capitalization weighting as the basis for a passive portfolio include that the index (and therefore a portfolio built on it) remains continually ‘in balance’ as market prices for the included securities change, and that the portfolio performance participates in (i.e., reflects) that of the securities market or market segment included in the index.

The disadvantages of market capitalization weighting passive indexes, which can be substantial, center on the fact that any under-valued securities are underweighted in the index and related portfolios, while any over-valued securities are over weighted. Also, the portfolio based on market capitalization weighting follows every market (or segment) bubble up and every market crash down. Finally, in general, portfolio securities selection is not based on a criteria that reflects a better opportunity for appreciation than that of the market or market segment overall.

Most commonly used stock market indices are constructed using a methodology that is based upon either the relative share prices of a sample of companies (such as the Dow Jones Industrial Average) or the relative market capitalization of a sample of companies (such as the S&P 500 Index or the FTSE 100 Index). The nature of the construction of both of these types of indices means that if the price or the market capitalization of one company rises relative to its peers it is accorded a larger weighting in the index. Alternatively, a company whose share price or market capitalization declines relative to the other companies in the index is accorded a smaller index weighting. This can create a situation where the index, index funds, or investors who desire their funds to closely track an index, are compelled to have a higher weighting in companies whose share prices or market capitalizations have already risen and a lower weighting in companies that have seen a decline in their share price or market capitalization.

Price or market capitalization based indices can contribute to a ‘herding’ behavior on the behalf of investors by effectively compelling any of the funds that attempt to follow these indices to have a larger weighting in shares as their price goes up and a lower weighting in shares that have declined in price. This creates unnecessary volatility, which is not in the interests of most investors. It may also lead to investment returns that have had to absorb the phenomenon of having to repeatedly increase weightings in shares after they have risen and reduce weightings in them after they have fallen.

Capitalization-weighted indexes (“cap-weighted indexes”) dominate the investment industry today, with approximately $2 trillion currently invested. Unfortunately, cap-weighted indexes suffer from an inherent flaw as they overweight all overvalued stocks and underweight all undervalued stocks. This causes cap-weighted indexes to under-perform relative to indexes that are immune to this shortcoming. In addition, cap-weighted indexes are vulnerable to speculative bubbles and emotional bear markets which may unnaturally drive up or down stock prices respectively.

Equal-weighted indexation is a popular alternative to cap-weighting but one that suffers from its own shortcomings One significant problem with equal-weighted indexes is that they come out of the same cap-weighted universes as cap-weighted indexes. For example, the S&P Equal Weighted Index simply re-weights the 500 equities that comprise the S&P 500, retaining the bias already inherent to cap-weighted indexes.

High turnover and associated high costs are additional problems of equal-weighted indexes. Equal-weighted indexes include small illiquid stocks, which are required to be held in equal proportion to the larger, more liquid stocks in the index. These small illiquid stocks must be traded as often as the larger stocks but at a higher cost because they are less liquid.

Cryptography relates to encoding data using encryption keys and the decryption of the encrypted data by use of the key. Cryptographic methods can be used to secure data. What is needed then is an improved method of weighting financial objects in a portfolio based on an index that overcomes shortcomings of conventional solutions.

### SUMMARY OF THE DISCLOSURE

In an exemplary embodiment a system, method and computer program product for index construction and/or portfolio weighting of financial objects for the purpose of investing in the index is disclosed.

An exemplary embodiment of the disclosure sets forth an electronic computer system used to support construction and management of data relating to security indexes.

An exemplary embodiment a system, method and computer program product computer implemented method can include: receiving electronically, by at least one special purpose index calculator computer device processor, a universe of publicly traded companies; receiving electronically, by the at least one special purpose index calculator computer device processor, from an electronic data source a plurality of metrics relating to the publicly traded companies, can include: corporate action data, price data, foreign exchange data, and fundamental financial metric data; combining electronically, by the at least one special purpose index calculator computer device processor, the plurality of metrics to calculate: a robustness ranking; a dividend yield percentile ranking; and a noncapitalization weighting for the publicly traded companies using, by the at least one special purpose index calculator computer device processor, the combined metric data to at least one of: a) electronically selecting or weighting, by the at least one special purpose index calculator computer device processor, constituents of an index based on the combined data; b) electronically selecting or weighting, by the at least one special purpose index calculator computer device processor, a portfolio of financial objects based on the combined data; or c) electronically allocating, by the at least one special purpose index calculator computer device processor, assets in a portfolio based on the combined data.

According to an exemplary embodiment, the computer implemented method can include where the receiving can include: receiving the plurality of metrics, wherein at least one of the plurality of metrics can include a non-price metric.

According to an exemplary embodiment, the computer implemented method can include where the robustness ranking can include: a ratio of income before extraordinary items to the book value of assets; a ratio of cash flow to short term debt plus interest expenses; and a net operating accruals cumulative difference between operating income and cash flow scaled by total assets.

According to an exemplary embodiment, the computer implemented method can include where the robustness ranking can include at least one of: a ratio of income before extraordinary items to the book value of assets; a ratio of cash flow to short term debt plus interest expenses; or a net operating accruals cumulative difference between operating income and cash flow scaled by total assets.

According to an exemplary embodiment, the computer implemented method can further include determining a fundamental equity income weight for each constituent of the universe.

According to an exemplary embodiment, the computer implemented method can further include screening, by the at least one special purpose index calculator computer device processor, the universe based on dividend yield and financial health.

According to an exemplary embodiment, the computer implemented method can include where the financial health is determined by analyzing, by the at least one special purpose index calculator computer device processor, the robustness measures.

According to an exemplary embodiment, the computer implemented method can further include banding, by the at least one special purpose index calculator computer device processor, to prevent excessive portfolio turnover.

According to an exemplary embodiment, the computer implemented method can include where the banding can include increasing weighting by 20% to current constituents.

According to an exemplary embodiment, the computer implemented method can further include applying, by the at least one special purpose index calculator computer device processor, liquidity constraints or limits to ensure sufficient liquidity volume to support inclusion by using a liquidity ratio of fundamental weight to liquidity weight.

According to an exemplary embodiment, the computer implemented method can include where the the dividend yield percentile ranking can include a trailing twelve month dividends per share divided by stock price as of the data cut-off date, and yield rank can include a percentile rank by dividend yield within relevant region or country ICB industry.

According to an exemplary embodiment, the computer implemented method can include where the method is executed on a special purpose computer electronically coupled to an analysis host computer, and electronically coupled to a trading host computer via an electronic and/or optical networking communications system providing realtime access to data of the electronic data source.

According to an exemplary embodiment, a computer data processing system can include: at least one special purpose processor; and at least one memory coupled to the special purpose processor, the processor configured to: receive electronically, by at least one special purpose index calculator computer device processor, a universe of publicly traded companies; receive electronically, by the at least one special purpose index calculator computer device processor, from an electronic data source a plurality of metrics relating to the publicly traded companies, can include: corporate action data, price data, foreign exchange data, and fundamental financial metric data; combine electronically, by the at least one special purpose index calculator computer device processor, the plurality of metrics to calculate: a robustness ranking; a dividend yield percentile ranking; and a noncapitalization weighting for the publicly traded companies use, by the at least one special purpose index calculator computer device processor, the combined metric data to at least one of: a) electronically select or weight, by the at least one special purpose index calculator computer device processor, constituents of an index based on the combined data; b) electronically select or weight, by the at least one special purpose index calculator computer device processor, a portfolio of financial objects based on the combined data; or c) electronically allocate, by the at least one special purpose index calculator computer device processor, assets in a portfolio based on the combined data.

### BRIEF DESCRIPTION OF THE DRAWINGS

FIG. 1A sets forth an exemplary embodiment of an index construction methodology according to an exemplary embodiment.

FIG. 1B is an exemplary deployment diagram of an exemplary special purpose index calculator computer-implemented index generation and use process in accordance with an exemplary embodiment of the present invention;

FIG. 2 is an exemplary computer-implemented process flow diagram of an index generation process in accordance with an exemplary embodiment of the present invention;

FIG. 3 is an exemplary process flow diagram of an index use process in accordance with an exemplary embodiment of the present invention;

FIG. 4 depicts a chart illustrating demand for equity income, discussing current 10-year yields leaving investors out of pocket, noting dividends provide an alternative income source, and noting exemplary dedicated income strategy can deliver further excess yield by identifying high yielding stocks, according to one exemplary embodiment;

FIG. 5 depicts an illustration noting potential concerns with conventional equity income strategies, including sustainability of high dividend distributions, high current yields may expose investors to risk, concentration risk, liquidity risk, transaction costs, and market cap weighted indices potential overexposure to expensive companies, according to an exemplary embodiment;

FIG. 6A depicts an exemplary embodiment of a computer system as may be used in the exemplary computer analysis host, exemplary computer trading host, or exemplary computer exchange host, according to an exemplary embodiment;

FIG. 6B depicts an exemplary embodiment of an exemplary index construction computer calculator secure data access system, according to an exemplary embodiment;

FIG. 7 depicts an exemplary embodiment of an exemplary improved measure of sustained income including an exemplary dividend yield and cash flow yield ranking to determine an exemplary income ranking, discussing using cash flow yield as a second measure of sustainability deemphasizing dividends financed through non-recurring sources and favors companies with strong operating income, according to an exemplary embodiment;

FIG. 8 depicts a block diagram of an exemplary embodiment of a system according to an exemplary embodiment;

FIG. 9 illustrates an exemplary method of identifying robust businesses via ranking companies based on an exemplary robustness ranking including an exemplary debt coverage score, an exemplary growth score, and an exemplary accounting quality score, according to an exemplary embodiment;

FIG. 10 illustrates an exemplary table discussing high yield stocks on three robustness measures noting a) an exemplary portfolio return, b) an exemplary portfolio volatility, and c) an exemplary Sharpe Ratio for each of i) high yield but not robust, ii) high yield and robust, and iii) difference from screening for robustness, concluding high yield stocks of companies with lower robustness underperform, according to an exemplary embodiment;

FIG. 11 illustrates an exemplary table discussing future five (5)-year cumulative dividend growth noting for each of a) All World, b) US, c) Europe, and d) Emerging Markets, noting i) Not Robust, ii) robust, iii)difference, and iv) t-stat, concluding dividend growth is linked to strength of indicators for robustness, according to an exemplary embodiment;

FIG. 12 illustrates an exemplary overview of the RESEARCH AFFILIATES FUNDAMENTAL INDEX (RAFI(R)) weighting scheme noting exemplary weighting metrics including not correlated with price, co-integrated with liquidity and capacity, economically representative, and avoiding structural portfolio biases, and notes the solution is a fundamental measure of firm size including, e.g., but not limited to, weighting based on an exemplary average of ranking by sales, cash flow, dividends, and book value, according to an exemplary embodiment;

FIG. 13 illustrates an exemplary overview of RAFI Equity Income weights, according to an exemplary embodiment, including centering of weights around RAFI weights for all stocks within each respective final universe, including increasing weight for higher income stocks and vice versa, increasing weight for stocks with higher robustness, and vice versa, including taking a fundamental weight, and multiplying each stock's fundamental weight by 1.0 adjusted by sum of a robustness adjustment, and sum of an income adjustment, according to an exemplary embodiment;

FIG. 14 depicts an exemplary flow diagram 1400 illustrating an intuitive and clear process starting with a RAFI universe, selecting stocks with higher than average income, based on dividend yield and cash-flow yield, and building high capacity portfolios of high income stocks from firms with robust financials by automatically electronically ranking and selecting, according to an exemplary embodiment;

FIG. 15 depicts exemplary charts 1500 illustrating exemplary strong yield pickup, including an above 2% yield pick up recently as well as on average historically, according to an exemplary embodiment;

FIG. 16 depicts exemplary charts 1600 illustrating substantial risk-adjusted value add charting exemplary value add, as well as information ratio, noting yield pick up does not come at the expense of return, indeed quite the opposite, according to an exemplary embodiment;

FIG. 17 illustrates how the RAFI equity income solution, according to an exemplary embodiment, provides a superior income solution noting exemplary advantages and also notes various performance related disclosures, according to an exemplary embodiment;

FIG. 18 depicts an exemplary table 1800 illustrating performance and characteristics of various exemplary RAFI Equity Income variations, according to an exemplary embodiment; and

FIG. 19 depicts an exemplary table 1900 illustrating performance and characteristics of various exemplary RAFI Equity Income variations for various valuations, according to an exemplary embodiment.

### DETAILED DESCRIPTION OF EXEMPLARY EMBODIMENTS OF THE DISCLOSURE

### Overview of Exemplary Equity Income Methodology

Exemplary steps, according to an exemplary embodiment can include, e.g., but are not limited to:
   a) selecting a universe,
   b) screening, and
   c) weighting, according to an exemplary embodiment.
Exemplary additional processing can include, e.g., but not limited to, do carve-outs for country/region indices, according to an exemplary embodiment.
a) Universe: An exemplary universe can include, e.g., but not limited to, being based on the FTSE Global All Cap Universe, which has about 7500 names, according to an exemplary embodiment.
   According to an exemplary embodiment, a component universe approach can be used to build a global master universe. According to an exemplary embodiment, the component universe approach can be a bottom up, instead of a top down approach. According to an exemplary embodiment, the approach can allow for a deeper universe and better regional representation in global portfolios. According to an exemplary embodiment, float adjusted values can be calculated, and constrains based on liquidity can be taken into account in obtaining the exemplary universe, according to an exemplary embodiment. Exemplary banding can be used to avoid excessive turnover.
   According to an exemplary embodiment, exemplary names can be scanned/searched for those companies that are in any of an exemplary five (5) regions, including, e.g., but not limited to: US, Japan, Europe, Other Developed, and EM, according to an exemplary embodiment.
   In an embodiment, every name in the universe can be ranked, using, e.g., but not limited to, a float-adjusted, liquidity constrained fundamental weight, according to an exemplary embodiment.
   After every name has been ranked by fundamental weight, names can be picked/selected from largest to smallest until the top 98^{th} percentile of all names have been selected, according to an exemplary embodiment. The 99^{th} percentile can be banded, according to an exemplary embodiment.
   This exemplary methodology can result in about 5000 company names, according to an exemplary embodiment.
b) Screening: According to an exemplary embodiment, exemplary screening can be based on an exemplary two (2) measures: i) dividend yield, and ii) financial health. Exemplary screens can be computed within region/industry groups (e.g., 50 groups in total), according to an exemplary embodiment.
   i) Dividend yield:
   For dividend yield, the top 50^{th} percentile of names based on trailing twelve (12) months (TTM) dividend yield can be taken, according to an exemplary embodiment.
   Exemplary TTM yield can be the sum of all dividends paid for the past 12 months, divided by an average daily share price for the past 12 months, according to an exemplary embodiment.
   ii) Financial health: According to an exemplary embodiment, an exemplary three (3) measures of financial robustness can be used, including, e.g., but not limited to: A) profitability, B) lack of distress, and C) accounting quality. According to an exemplary embodiment, measures can be used to ensure that so-called “dogs” are eliminated, i.e., screened if the associated company's financial health is suspect, under any of various exemplary screening measures.
   For (A) profitability, return on assets (ROA) can be used, according to an exemplary embodiment.
   For (B) distress, debt coverage ratio (i.e., liabilities/assets) can be used, according to an exemplary embodiment.
   And as an indication of (C) accounting quality, scaled net operating accruals (NOAs (e.g., sum of accruals, accumulation of accruals) can be used, according to an exemplary embodiment.
   Each of these three exemplary financial robustness measures can be ranked, and each company can be assigned the lowest percentile rank that the company/stock receives for any measure, according to an exemplary embodiment. This percentile rank can be called the minimum robustness rank (MRR), according to an exemplary embodiment.
   Any company can be thrown out whose MRR can be found to fall into the bottom 20^{th} percentile, according to an exemplary embodiment.
Exemplary 20% banding can be used for both exemplary screens, according to an exemplary embodiment. Any company that is already in the portfolio can get its percentile rank increased by 20% in subsequent years, according to an exemplary embodiment.
[Side note: Wells Fargo (WF), which is an example of a top position in EI, is also the poster child for banding. WF's dividend yield rank sits right on the 50^{th} percentile line but because of banding it can remain in the portfolio, in an exemplary embodiment.]
This exemplary process can result in about 1200 exemplary companies, according to an exemplary embodiment.
   c) Weighting: According to an exemplary embodiment, the remaining approximately 1200 names can be taken, and the list of these companies can then be weighted (or reweighted) by multiplying each of the companies' fundamental scores by the companies' dividend yields.
      According to an exemplary embodiment, this can create the equity income (EI) master portfolio. According to an exemplary embodiment, from the master portfolio, any region or country index can be carved out therefrom.
      According to an exemplary embodiment, after carving out a particular country and/or region, weights can be normalized (or renormalized), and each name's weight can be capped at an exemplary value such as, e.g., but not limited to, 5% (i.e., a weighting can be restricted so as not to be too big, or too small). According to an exemplary embodiment, any names with a weight lower than 10 bps (i.e., one tenth of one percent, or 0.001) can be removed.

According to an exemplary embodiment, the exemplary methodology can process substantial volumes of data, using computationally demanding analysis of the financial accounting data of thousands of companies in the universe, and large volumes of historical data. Calculating dividend yield, according to an exemplary embodiment, can use relatively fresh, reasonably short term data can be obtained, namely, the exemplary trailing twelve (12) months of dividends paid, from the use of exemplary trailing twelve (12) days of trading. According to an exemplary embodiment, long term data can be focused upon, by using an exemplary 7,500 company dataset, multiplied by an exemplary five (5) regions, multiplied by an exemplary four (4) fundamental measures (such as, e.g., but not limited to, revenues, cashflow, book value, and/or any dividends, etc., according to an exemplary embodiment), multiplied by a decade worth of data, i.e., by ten (10) years of data, multiplied by four (4) quarters of data, plus taking into account exemplary banding to avoid excess turnover.

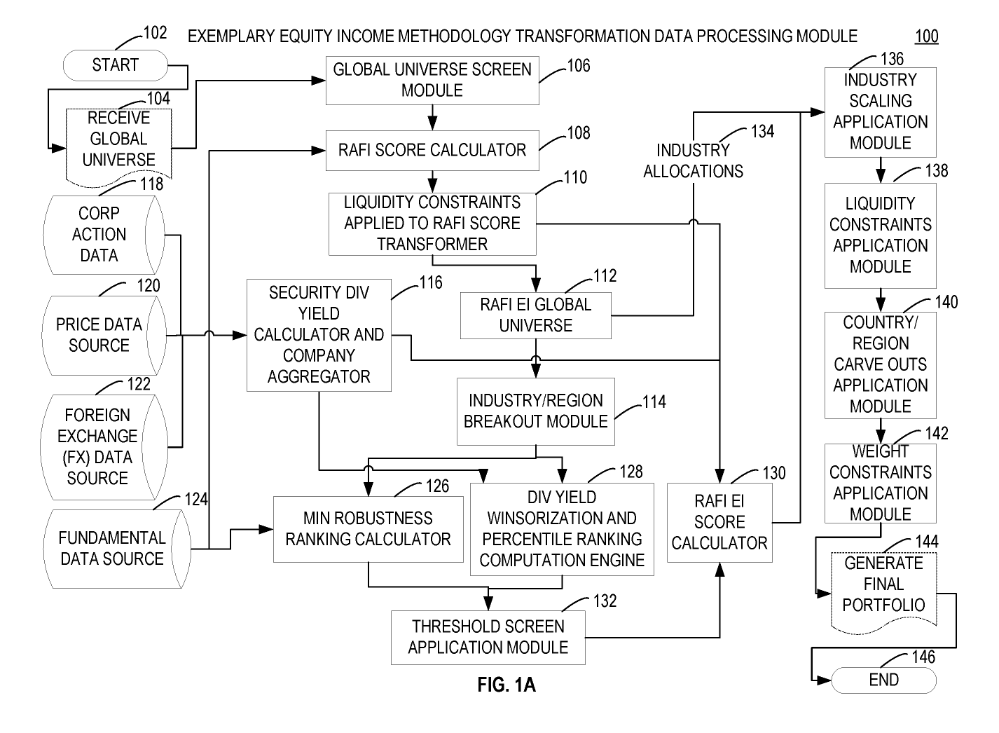

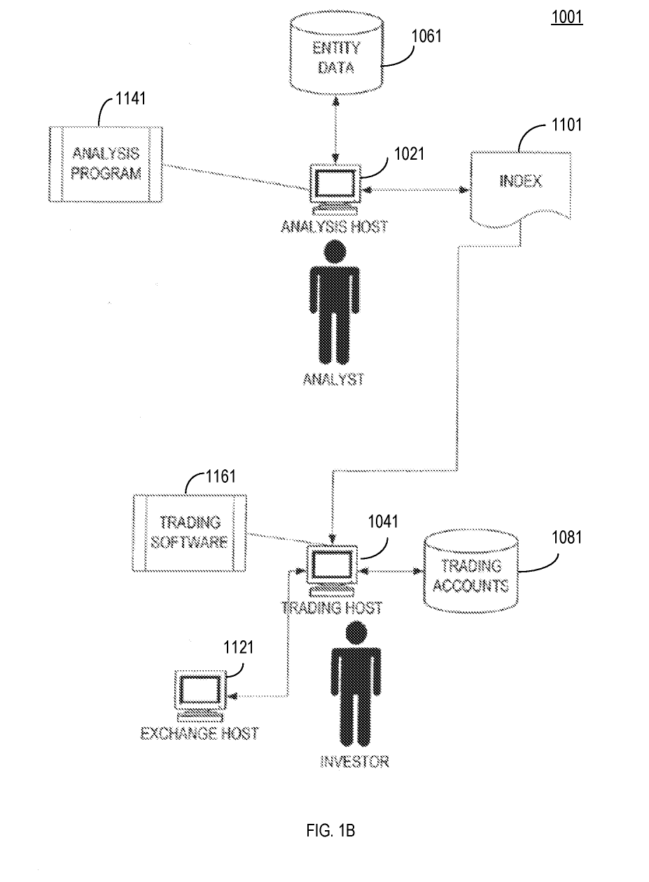

FIG. 1A sets forth an exemplary embodiment of an index construction methodology according to an exemplary embodiment.

The RAFI Equity Income methodology according to an exemplary embodiment can include the following:

1) Start with a fundamentally weighted index such as, e.g., but not limited to, RAFI parent index (e.g., RAFI US 1000) available from Research Affiliates, LLC, Newport Beach, Calif. USA.

2) Screen out names whose dividend yields are lower than the respective CAP benchmark dividend yield (see Note c)

3) Choose top 250 names using RAFI EI Score as follows:

RAFI EI Score=RAFI Fundamental Weight×(1+Robustness Adjustment+Income Adjustment) (see Note a)

i. Robustness Score=⅓ Debt Coverage Score+⅓ Growth Score+⅓ Accounting Quality Score (see Note b)

ii. Income Score=½ Dividend Yield Rank+½ Cash Flow Yield Rank

(Note a) Any stock that theoretically had 0 score for both Robustness and Income would simply maintain its baseline RAFI Fundamental Score

(Note b) Any stock that falls in the bottom quintile for any of these 3 measures is effectively screened out.

(Note c) Note that 2 exemplary embodiment variations of step 2 are being contemplated:
Variation 1: screen in names with the constraint:
   Dividend yield >CAP benchmark dividend yield
Variation 2: screen in names with two constraints:
   1. Dividend yield >CAP benchmark dividend yield -AND-
   2. Cash flow yield >CAP benchmark cash flow yield

### Exemplary Embodiment of an Exemplary Equity Income Methodology Transformation Data Processing Module

FIG. 1A depicts an exemplary Equity Income Methodology Transformation Data Processing Module 100 special purpose index construction computer system and process for creating and/or generating and managing an exemplary equity income methodology according to an exemplary embodiment.

Exemplary equity income methodology 100 can begin with 102 and can immediately continue with 104.

In 104, the equity income transformation data processing module can receive as input a global universe, which according to an exemplary embodiment can include all publicly traded stocks. For example, the S&P global companies and/or FTSE global all capitalizations, all geographic sectors can be used, in one exemplary embodiment. This exemplary universe can include approximately 7,600 companies. Each of the 7,600 records can include various fields including, but not limited to, security identifier (ID), country classification, industry classification, adjusted market capitalization (used for initial capitalization screen, etc.), and nonadjusted market capitalization, currency code (obtained from corporate action database 118), etc. From 104, 100 can continue with 106, according to an exemplary embodiment.

In 106, global universe screen module 106 can take the original universe and can analyze appropriate countries, accompanying in certain country groups and the industry can be defined, as the system may need to be able to map to an industry. The system can filter out securities that cannot be mapped to a company in the fundamental data. Thus, 7,600 companies can be screened down to approximately 7,000-7,500 companies. From 106, 100 can continue with 108, according to an exemplary embodiment.

In 108, the RAFI score can be calculated. Also, 108 receives data from fundamental data source 124 as shown, in one exemplary embodiment. The fundamental data received, includes substantial accounting data about the approximately 7,000 companies to allow calculating fundamental RAFI scores including, e.g., using four factor RAFI, including revenues, book value, cashflow, and any dividends. The RAFI score calculator 108 can use the fundamental financial data and the global universe, and can use the classical RAFI factors, in one exemplary embodiment, namely, Sales/Revenue, cashflow, bookvalue, and any dividends, and more particularly, for sales, dividends and cashflow, the most recent five (5) years annual data can be normalized and then averaged, and for book value the most recent data can be used, and then the final RAFI scores can be calculated using the special purpose calculator, and can be provided to 110. From 108, 100 can continue with 110, according to an exemplary embodiment.

Fundamental data 124 can include any of various accounting data sources including, e.g., but not limited to, the BLOOMBERG universe of fundamental data, such as, e.g., but not limited to, information on 80,000 companies, 120,000 securities, including financial accounting data.

In 110, liquidity constraints can be applied to the RAFI score for the companies. To calculated a free float ratio, it can use the RAFI score from Bloomberg data, and data on volume from Bloomberg volume data, and can use certain trading volume thresholds, capping any given company to a weight that is a multiple for each company of a RAFI weight set no larger than a multiple of volume weight and then can be renormalized to get everything to add up to 100%. From 110, 100 can continue with 112, according to an exemplary embodiment.

In 112, the RAFI equity income global universe 112 can be formed, by accumulating the weights from largest to smallest and stopping at 98% of cumulative threshold. This can be done in bins by country, or by country group. In an exemplary embodiment, the country groups can be US, Japan, developed Europe, Other developed, and global emerging, etc. From 112, 100 can continue with 114, according to an exemplary embodiment.

As shown, corporate action data 118, price data source 120, and foreign exchange (FX) data source 122 can provide data to security dividend yield calculator and company aggregator 116, according to an exemplary embodiment. 116 can provide results to both industry/region breakout module 114, and RAFI Equity Income (EI) score calculator 130, according to an exemplary embodiment.

In 114, an industry region breakout module can for all the remaining companies place the companies in an exemplary fifty (50) bins for the five (5) exemplary region groups, multiplied by the ten (10) ICB industries, where each company fits in one bucket, and then the system looks at where the company ranks, using dividend yield, and the top 50% can be taken. From 114, 100 can continue with 126 and 128, according to an exemplary embodiment.

In 126, a minimum robustness calculator can calculate and rank the exemplary robustness metrics, using exemplary three (3) metrics using fundamental data obtained from fundamental data source 124, a) return on assets (ROA), i.e., a ratio of income before extraordinary items (Nibex) to the book value of the assets (Assets), b) coverage ratio, DCR, i.e., the ratio of cash flow to short term debt plus interest expenses, c) scaled net operating accruals (NOAs), i.e., cumulative difference between operating income and cash flow scaled by total assets, NOAs can be ranked in descending order. For a given company, the robustness metrics can be analyzed, and where the company falls in the percentiles can be determined, and if any of the metrics is less than the 20^{th} percentile, then the company is removed. From 126, 100 can continue with 132, according to an exemplary embodiment.

In 128, the dividend yield winsorization and percentile ranking computation engine can use the dividend yield and percentile ranking to take an exemplary top 50 percentile. Module 128 can receive dividend yield data from security dividend yield calculator and company aggregator 116. From 128, 100 can continue with 132, according to an exemplary embodiment

Security dividend yield calculator and company aggregator 116 can receive data from corporate action data provider 118 (can provide the currency code to assist in calculating yield), price data source 120, and foreign exchange (FX) data source 122, and can calculate a dividend yield. The dividend yield can be calculated for a security at a company level. For example, an exemplary calculator can divide the sum of the dividend payments for the year, by the average price of the stock for the year. The numerator of the division can be the sum of all US dividend payments (after currency conversion and adjustments), and this can be divided by the denominator quantity of average daily share price for the year. The dividend yield over the year can be used, rather than just on the date of the payment. For example, for each effective date, and quarterly, any dividend payments must be determined from corporate action data 118, and the dividends need to be converted to US dollars, using foreign exchange data 122, and conversion to US currency uses local currency price data 120. There can be caps of dividends of particular dividend types, and within 1 year, gross or net and of dividends.

In 132, a threshold screen application module 132 can apply the screens to result in approximately 1,200 companies, in one exemplary embodiment. According to an exemplary embodiment, for a given bin, it can be determined whether and how many meet the dividend yield screen, and then it can be determined how many also meet the minimum robustness screen. From 132, 100 can continue with 130, according to an exemplary embodiment.

In 130, the RAFI Equity Income (EI) score calculator 130 can calculate RAFI EI scores for all the particular companies it receives from the threshold screen application module 132, and using the liquidity constrains applied to RAFI score transformer 110, as shown, according to an exemplary embodiment. Calculator 130 takes the RAFI weights and normalizes. 130 has about 1,200 company stocks, once processing is complete. From 130, 100 can continue with 136, according to an exemplary embodiment.

In 136, industry scaling application module 136 can look at cumulatively, weights in each industry, and can adjust weights in each industry. The module 136 can look at the 5 exemplary regions and at the RAFI industry allocations within each of the regions. For example, if 50% of the US is related to oil, then the EI can be scaled based on US oil of approximately 20%, so the weight can be scaled to mainline. This scaling attempts to avoid allowing some industries to become over concentrated, so the module can use another index, such as, e.g., the FTSE RAFI index as a comparison to determine an appropriate industry concentration. From 136, 100 can continue with 138, according to an exemplary embodiment.

In 138, similar to the discussion of 110, the liquidity constraints can be reapplied. For example, for each company, a RAFI weight can be set no larger than a multiple of volume weight and then can be renormalized to get everything to add up to 100%. From 138, 100 can continue with 140, according to an exemplary embodiment.

In 140, country/region carve outs can be performed using this application module 140, so if there are 1,200 companies, the companies can be broken up into US only, e.g., 160, and All world, e.g., 200. The index can be sliced and diced, divided and/or combined, by region, as can be useful. From 140, 100 can continue with 142, according to an exemplary embodiment.

In 142, weight constraints application module can apply any weight constraints. From 142, 100 can continue with 144, according to an exemplary embodiment.

In 144, a final portfolio can be generated, based on the output of the prior stages and modules, and the final portfolio data can then be used to purchase/acquire securities according to the final portfolio selections and weightings, such as an exchange traded fund (ETF) or a mutual fund, that can then be sold to individuals, retail investors, etc. From 144, 100 can continue with 146, and can immediately end, according to one exemplary embodiment.

Banding can be used, according to an exemplary embodiment, e.g., to avoid turnover. In initial universe calculation of 104/106, banding can be used to choose the largest companies by fundamental data until cumulatively 98% is obtained. Banding can take an additional 1%, in an exemplary embodiment, so if a former constituent was bumped, then that company can be included in the universe, for example. Another exemplary time banding can be implemented, is for calculating each of the three robustness measures, if a name of a company is in a portfolio, it will stay in if its percentile rank doesn't fall more than 20%, i.e., this gives a current constituent about a 20% bump, so if you have 50%, then multiply by 1.2. If a company is already in, then a new year score can be calculated and can be multiplied by 1.2 to give that company a bump, to avoid portfolio turnover. Similarly, for dividend yield calculation, a company previously in the portfolio can also be given a bump, according to one exemplary embodiment.

### Exemplary Computer System Embodiments

FIG. 1B depicts an exemplary special purpose index construction computer system that may be used in an exemplary embodiment of the claimed invention. FIG. 1B depicts an exemplary deployment diagram 1001 of an index construction, generation and use computer implemented process executing upon a special purpose index construction computer system in accordance with an exemplary embodiment of the present invention. According to an exemplary embodiment, an analyst may use a computer system 1021 to generate an index 1101. The analyst may do so by using analysis software 1141 to examine data 1061 about entities offering different kinds of financial objects that may, for example, be traded by investors. An example of an entity that may be offering financial objects may be a publicly held company whose shares trade on an exchange. However, the present embodiments also apply to any entity that may have any type of financial object that may, for example, be traded, and where, for example, information about the entity and/or its financial objects may be available (or capable of being made available) for analysis.

In an exemplary embodiment, once index 1101 has been generated by an analyst using the entity data 1061, index 1101 may be used to build one or more portfolios, for example, investment portfolios. An investor, advisor, manager or broker may then manage the purchased financial objects, for example, as a mutual fund, an electronic traded fund, a hedge fund or other portfolio or account of assets for one or for a plurality of, for example, individual and/or institutional investors. The investor, advisor, manager or broker may use a trading computer system 1041 with trading software 1161 to manage one or more trading accounts 1081. Alternatively, the purchased financial objects may be managed for one or more investors. In the latter case, financial objects may be purchased based on the index for inclusion in an individual or an institutional investor's portfolio. One or more trades may be effected or closed in cooperation with and via communication with an exchange host system 1121. The present embodiments are not limited to the foregoing technologies, and may include at a minimum, the various technologies, including computer and/or communications systems specified elsewhere herein.

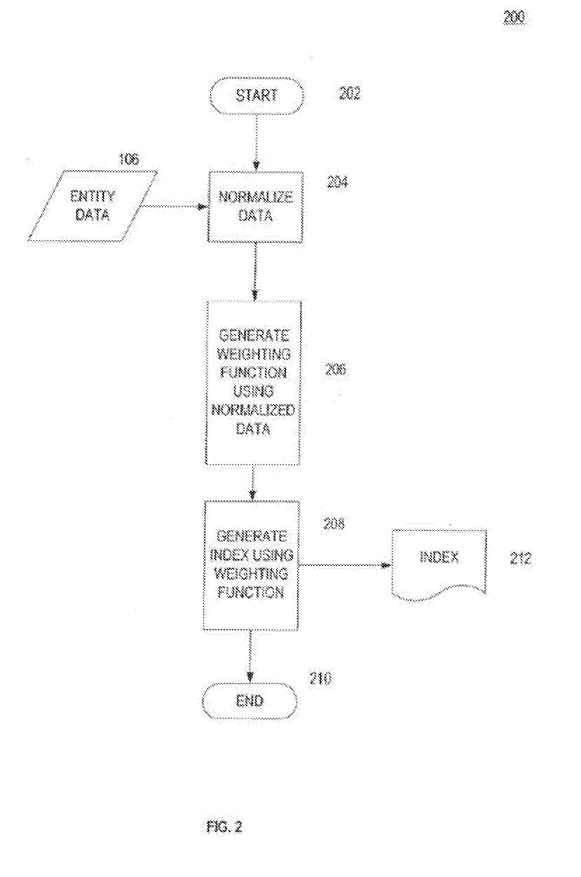

FIG. 2 depicts an exemplary process flow diagram 200 of an index generation process in accordance with an exemplary embodiment of the present invention. In an exemplary embodiment, starting at block 202, to generate index 1101, an analyst using analysis software and/or hardware system 1141 may access entity data 1061 about various entities that have financial objects that are traded. For example, publicly traded companies must disclose information about certain financial aspects of their operations. This information may be aggregated for a plurality of entities. Market sectors and corresponding indices may then be identified and generated using the aggregate data.

In slightly more detail, an index 1101 may be generated and/or stored by, for example, normalizing entity data for a particular non-market capitalization metric in block 204. The normalized entity data may be used to generate a weighting function, in block 206, describing the contribution of each entity to a business sector as defined by the metric, in an exemplary embodiment. Index 1101 may be generated using the weighting function in block 208. The process may end at block 210. Once index 1101 is generated, according to an exemplary embodiment, index 1101 may be used to track the business sector defined by the metric or to create a portfolio of financial objects offered by the entities whose information was used to generate the index.

For example, in an exemplary embodiment a method of constructing a non-capitalization weighted portfolio of financial objects may include, e.g., gathering data about various financial objects; selecting a group of financial objects to create the index of financial objects; and/or weighting each of the group of financial objects selected in the index based on an objective measure of scale and/or size of each member of the group of financial objects, where the weighting may include weighting all or a subset of the group of financial objects, and weighting based on factors other than market capitalization, equal weighting, or share price weighting.

In one exemplary embodiment, the weighting of each member of the group of financial objects may include weighting financial objects of any of various types. Examples of various types of financial objects may include, for example, but not be limited to, a stock type; a commodity type; a futures contract type; a bond type; a currency type; a mutual fund type; a hedge fund type; a fund of funds type; an exchange traded fund (ETF) type; and/or a derivative type asset, and/or any other portfolio or account of financial objects, to name a few. In fact, any of the types of financial objects specified above and elsewhere herein may be weighted. The weighting may also include, e.g., but not limited to, a negative weighting on any of the various types of financial objects.

According to exemplary embodiments of the present invention, the index 1101 may be weighted based on an objective measure of scale and/or size, where the objective measure of scale and/or size may include a measure relating to an underlying asset itself. The financial object may include, for example, a government and/or a municipality, a government and/or municipality issuing bonds, a government and/or municipality issuing currency, a government and/or municipality issuing a commodity, and/or a government and/or municipality issuing a commodity, to name a few. An objective measure of scale and/or size associated with the financial object may include, for example, any combination or ratios of: revenue, profitability, sales, total sales, foreign sales, domestic sales, net sales, gross sales, profit margin, operating margin, retained earnings, earnings per share, book value, book value adjusted for inflation, book value adjusted for replacement cost, book value adjusted for liquidation value, dividends, assets, tangible assets, intangible assets, fixed assets, property, plant, equipment, goodwill, replacement value of assets, liquidation value of assets, liabilities, long term liabilities, short term liabilities, net worth, research and development expense, accounts receivable, earnings before interest, taxes, dividends, and amortization (EBITDA), accounts payable, cost of goods sold (CGS), debt ratio, budget, capital budget, cash budget, direct labor budget, factory overhead budget, operating budget, sales budget, inventory method, type of stock offered, liquidity, book income, tax income, capitalization of earnings, capitalization of goodwill, capitalization of interest, capitalization of revenue, capital spending, cash, compensation, employee turnover, overhead costs, credit rating, growth rate, dividends, dividends per share, dividend yields, tax rate, liquidation value of company, capitalization of cash, capitalization of earnings, capitalization of revenue, cash flow, and/or future value of expected cash flow. Further, if the financial object is associated with country or sovereign, such as, for example, emerging market debt instruments or currency and currency related debt instruments, an objective measure of scale and/or size associated with the financial object may include any combination or ratio of: economic factors, demographic factors, social factors political factors, the population, area, geographic area gross domestic product (GDP), GDP growth, natural resources, oil (or any other energy source) consumption, expenditures, government expenditures, gross national income (GNI), measures of freedom, democracy, and corruption, rate of inflation, rate of unemployment, reserves level, and/or total debt, nominal interest rates and the ratios of nominal interest rates between issuing sovereign entities; commercial paper yield metric; credit rating metric; consumer price index (CPI); purchasing power of local currency metric; metrics measuring relations between the purchasing power of local currency metric and nominal exchange rates and deviations from historical trends in such metrics; and/or government exchange rate regime; a per capita ratio of any of the foregoing or any other characteristic.

Ratios too may be used. In an exemplary embodiment, the weighting of financial objects in the index based on objective measures of scale and/or size may include a ratio of any combination of the objective measures of scale and/or size of the financial object other than ratios based on weighting the financial objects based on market capitalization, equal weighting, or share price weighting. For example, the ratio of any combination of the objective measures of scale and/or size may include, e.g., but not limited to, current ratio, debt ratio, overhead expense as a percent of sales, or debt service burden ratio.

In an exemplary embodiment, the portfolio of financial objects may include, e.g., but not limited to, one or more of, a fund; a mutual fund; a fund of funds; an asset account; an exchange traded fund (ETF); and/or a separate account, a pooled trust; a limited partnership and/or other legal entity, fund or account.

In an exemplary embodiment, a measure of company size may include one of, or a combination of one or more of, gross revenue, sales, income, earnings before interest and tax (EBIT), earnings before interest, taxes, depreciation and amortization (EBITDA), number of employees, book value, assets, liabilities, net worth, cash flow or dividends.

In one exemplary embodiment, the measure of company size may include a demographic measure of the financial object. The demographic measure of the financial object may include, e.g., one of, or any combination of one or more of a non-financial metric, a non-market related metric, a number of employees, floor space, office space, or other demographics of the financial object.

In an exemplary embodiment, weighting may be based on the objective measure of scale and/or size, where the measure may include a geographic metric. The geographic metric in an exemplary embodiment may include a geographic metric other than gross domestic product (GDP) weighting.

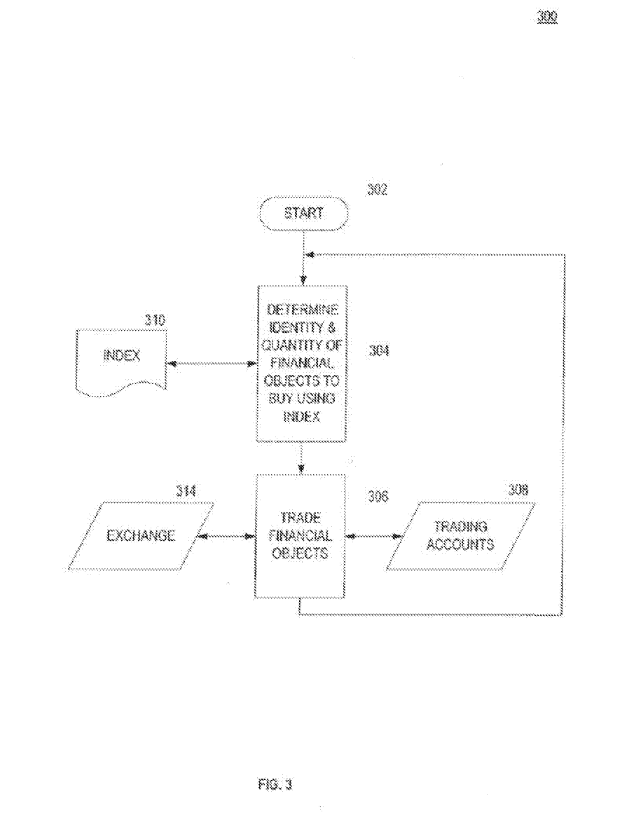

FIG. 3 depicts an exemplary index use process diagram 300 in accordance with an exemplary embodiment of the present invention. The process may start with 302 with an index being received from an index generation process and may be used to determine the identity and quantity of securities to purchase for a portfolio in 304, according to an exemplary embodiment. The securities may be purchased, in 306, from an exchange or other market and may be held on account for an investor or group of investors in trading accounts 308. The index 310 may be updated on, e.g., but not limited to, a periodic basis and may be used as a basis to rebalance the portfolio, according to an exemplary embodiment. According to another exemplary embodiment, the portfolio can be rebalanced when, e.g., a pre-determined threshold is reached. In this way, a portfolio may be created and maintained based on a non-market capitalization index.

Rebalancing can be based on financial objects reaching a threshold condition or value. For example, but not limited to, rebalancing may occur upon reaching a threshold such as, e.g., ‘when the portfolio of financial objects increases in market value by 20%,’ or ‘when the financial objects on a sub-category within the portfolio exceed 32% of the size of the portfolio,’ or ‘when a U.S. President is elected from a different party than the incumbent,’ etc. Rebalancing may take place periodically, e.g., quarterly, or annually.

The present invention, in an exemplary embodiment, may be used for investment management, or investment portfolio benchmarking.

Another exemplary embodiment of the present invention may include an Accounting Data Based Index (ADBI) such as, e.g., but not limited to, a FUNDAMENTAL INDEXED and Index Fund or Funds.

This exemplary embodiment may utilize a new series of accounting data based stock market indices in which the index weightings may be determined by company accounting data such as, e.g., but not limited to, the relative size of a company's profits, or its pre-exceptional profits, or sales, or return on investment or any accounting data based accounting item, or ratio, may help to address some of the issues raised above. An index that is weighted based on company accounting data, rather than the share price, or market capitalization or equal weighting, may have a stabilizing element within it that can help to remove excess volatility generated by indices constructed on the basis of price or market capitalization alone. Over the medium to longer term, such accounting data based indices have the potential to outperform price or market capitalization-based indices, and may do so with less volatility.

The exemplary method may create a new class of stock market indices and index funds that may be implemented on, e.g., but not limited to, a computing device or a processor, or as a computer software or hardware, or as an algorithm. This new class of stock market indices may base its weightings on the accounting data of the companies that make up that index. One possible version of an accounting data based stock market index may be an index that is based on the relative size of a sample of the companies' pre-exceptional profits. If the chosen sample of companies was determined to be one hundred and the accounting data based criteria that the index manager decided to use was to be largest pre-exceptional profits,' then the index may contain, e.g., the one hundred largest companies as defined by the size of their pre-exceptional profits. As an example, if the total pre-exceptional profits of the largest one hundred companies, as measured by their pre-exceptional profits, was 100 dollars, pounds, or other currency, in a defined time period (such as a quarter or year) and in the same time period the pre-exceptional profits of theoretical company ‘A’ were $2, then theoretical company A would be allocated a 2% weighting in the accounting data based index, in an exemplary embodiment. If theoretical company B had pre-exceptional profits of $1.5 over the same time period then it would have a weighting of 1.5% in the accounting data based index according to an exemplary embodiment.

The index weightings may be managed based on how the “fundamentals” of the companies within, or outside, the chosen index sample may change. As an example, the index manager could choose to rebalance the weightings from time to time such as, e.g., but not limited to, periodically, aperiodically, quarterly, as company pre-exceptional profits change, and/or on an annual basis, etc., and enter their choice into, e.g., a computing device. If, for instance, by the time of the next rebalancing period the total pre-exceptional profits of the largest one hundred companies, as measured by their pre-exceptional profits, had grown to $120, and theoretical company A now had pre-exceptional profits of $1.2, the computing device may calculate the weighting of company in the accounting data based index such as, e.g., the accounting data based index down to 1% from 2% in the previous period. Creating such accounting data based indices may give an investor the opportunity to follow, or invest, passively in an index which may be anchored to the economic realities of the companies within it. This new accounting data based index construction technique by a computing device may produce an index and related index fund products with increased stability and with increased economically rational behavior as compared with known methods of investing.

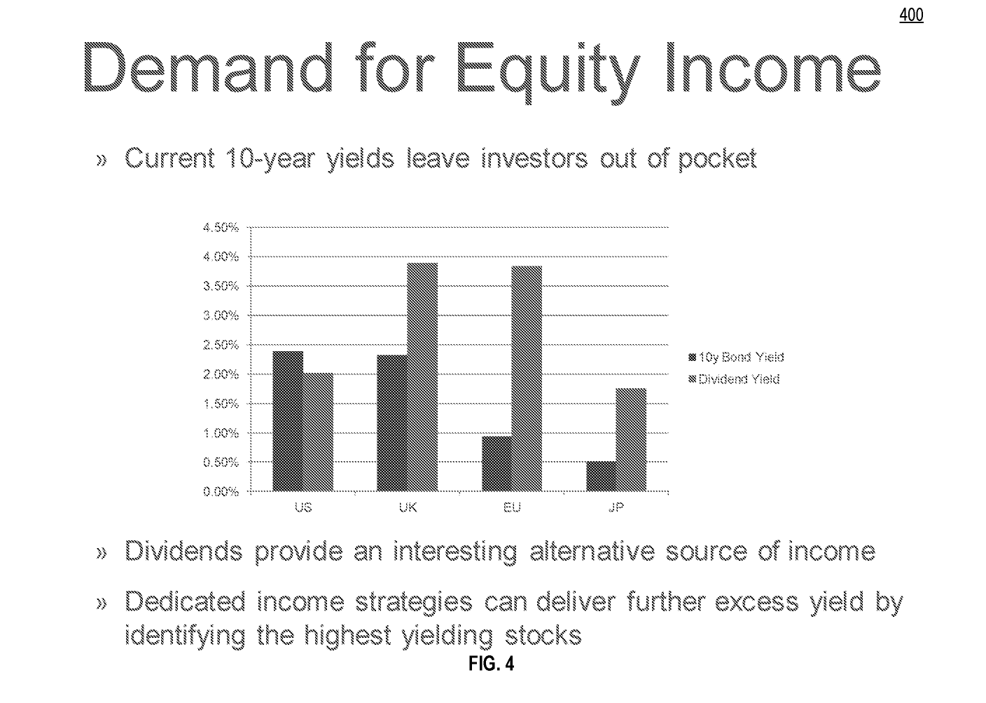

FIG. 4 depicts a chart 400 illustrating demand for equity income, discussing current 10-year yields leaving investors out of pocket, noting dividends provide an alternative income source, and noting exemplary dedicated income strategy can deliver further excess yield by identifying high yielding stocks, according to one exemplary embodiment.

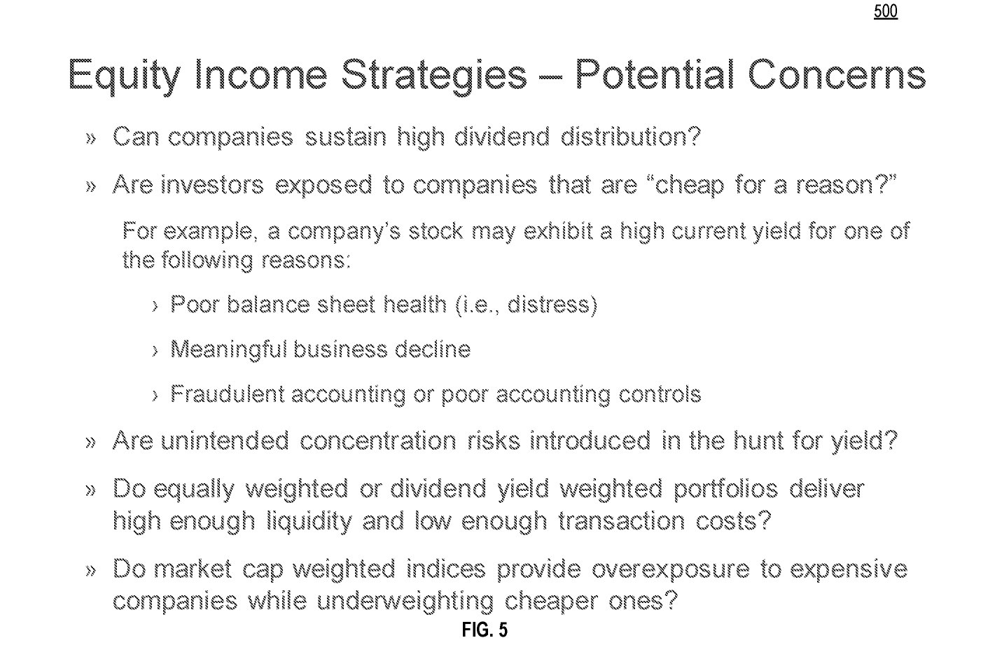

FIG. 5 depicts an illustration 500 noting potential concerns with conventional equity income strategies, including sustainability of high dividend distributions, high current yields may expose investors to risk, concentration risk, liquidity risk, transaction costs, and market cap weighted indices potential overexposure to expensive companies, according to an exemplary embodiment.

### Exemplary Computer System Embodiments

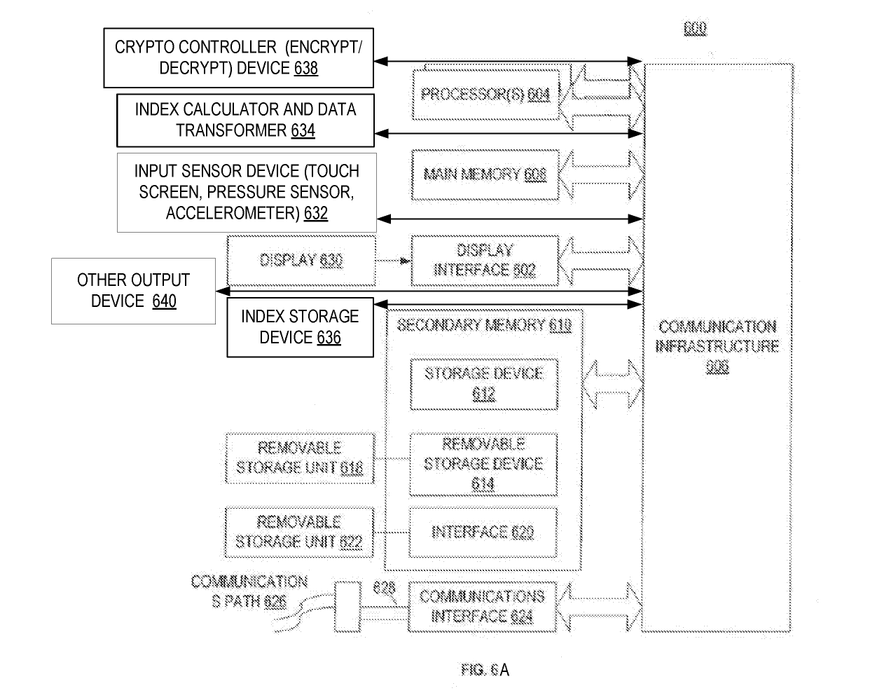

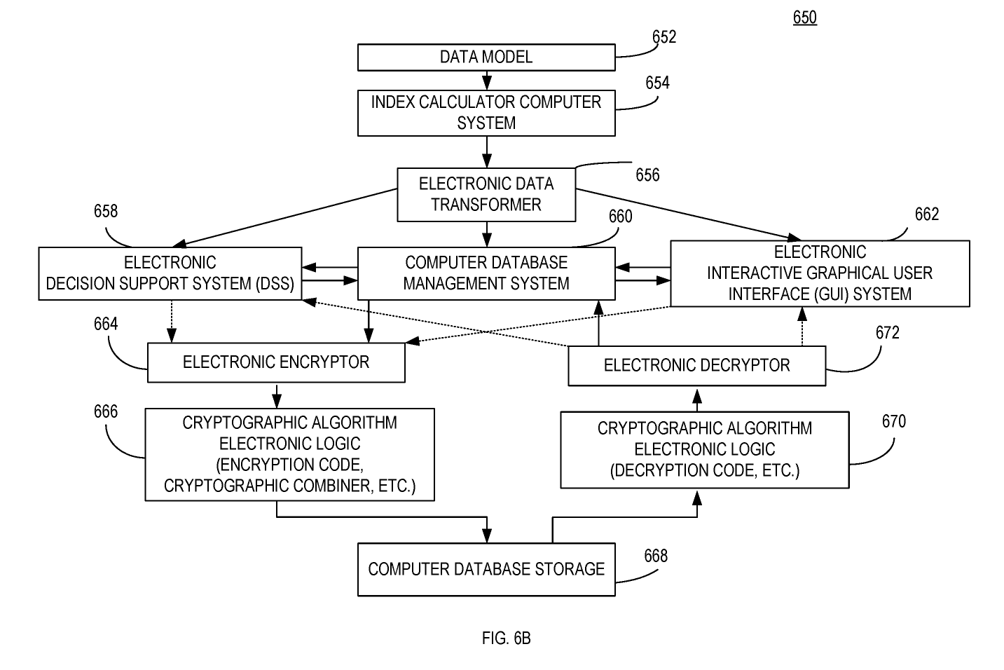

FIG. 6A depicts an exemplary special purpose index construction computer system that may be used in implementing an exemplary embodiment of the present invention. Specifically, FIG. 6A depicts an exemplary embodiment of an exemplary special purpose index construction computer system 600 that may be used in computing devices such as, e.g., but not limited to, a client and/or a server, etc., according to an exemplary embodiment of the present invention. FIG. 6A depicts an exemplary embodiment of the exemplary special purpose index construction computer system that may be used as client device 600, or a server device 600, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more exemplary special purpose index construction computer systems capable of carrying out the functionality described herein. An example of the exemplary special purpose index construction computer system 600 may be shown in FIG. 6A, depicting an exemplary embodiment of a block diagram of an exemplary computer system useful for implementing the present invention. The exemplary special purpose index construction can include various inputs and/or outputs including any of various sensors including, e.g., but not limited to, touch screens, touch sensors, pressure sensors, accelerometers, location sensors, accounting data database collection sensor/gatherers, financial index storage datasets data sensors, etc. Specifically, FIG. 6A illustrates an example special purpose index construction computer 600, which in an exemplary embodiment may be, e.g., (but not limited to) a special purpose personal computer (PC) system in one exemplary embodiment, running an operating system such as, e.g., (but not limited to) MICROSOFT® WINDOWS.degree. 10/8.1/8/7/NT/98/2000/XP/CE/ME/VISTA, etc. available from MICROSOFT® Corporation of Redmond, Wash., U.S.A. However, the invention may not be limited to these platforms. Instead, the invention may be implemented on any appropriate exemplary special purpose index construction computer system running any appropriate operating system such as, e.g., but not limited to, Mac OSX, a Mach system, UNIX, iOS, Android (available from Alphabet, and/or Google), etc., and/or another programming environment such as, e.g., but not limited to, Java, or the like. In one exemplary embodiment, the present invention may be implemented on an exemplary special purpose index construction computer system, including a computer processor, and memory, with instructions stored in the memory configured to be executed on the computer processor, operating as discussed herein. An exemplary special purpose index construction computer system, exemplary special purpose index construction computer 600 may be shown in FIG. 6A. Other components of the invention, such as, e.g., (but not limited to) a special purpose index construction computing device, a communications device, mobile phone, a telephony device, a telephone, a personal digital assistant (PDA), a personal computer (PC), a handheld PC, an interactive television (iTV), a digital video recorder (DVD), a tablet computer, an iPad, an iPhone, an Android phone, a Phablet, a mobile device, a smartphone, a wearable device, a network appliance, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 6A. Services may be provided on demand using, e.g., but not limited to, an interactive television (iTV), a video on demand system (VOD), and via a digital video recorder (DVR), or other on demand viewing system.

The exemplary special purpose index construction calculator computer system 600 may include one or more processors, such as, e.g., but not limited to, processor(s) 604. The exemplary special purpose index construction processor(s) 604 may be connected and/or coupled to a communication infrastructure 606 (such as, e.g., but not limited to, a communications bus, cross-over bar, or network, etc.). Various exemplary software embodiments may be described in terms of this exemplary special purpose index construction computer system. After reading this description, it may become apparent to a person skilled in the relevant art(s) how to implement the invention using other exemplary special purpose index construction computer systems and/or architectures. According to an exemplary embodiment, the system can include an index construction calculator and data transformer 634. In an exemplary embodiment, a cryptographic controller can be included, in an exemplary embodiment, and can be used to, e.g., but not limited to, authenticate a user device, and/or provide encryption and/or decryption processing, according to an exemplary embodiment

Exemplary special purpose index construction calculator computer system 600 may include a display interface 602 that may forward, e.g., but not limited to, graphics, text, and other data, etc., from the communication infrastructure 606 (or from a frame buffer, etc., not shown) for display on the display unit 630, or other output device 640 (such as, e.g., but not limited to, a touchscreen, etc.).

The exemplary special purpose index construction computer system 600 may also include, e.g., but may not be limited to, a main memory 608, random access memory (RAM), and a secondary memory 610, etc. The secondary memory 610 may include, for example, (but not limited to) a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, solid state disc (SSD), SDRAM, Flash, a thumb device, a USB device, optical disk, compact disk, etc. which may be read from and written to by removable storage drive 614. As may be appreciated, the removable storage unit 618 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CDROM) or a digital versatile disk (DVD); a magnetic tape; and/or a memory chip, etc. Communications networking subsystem can be coupled to an electronic network coupled to a data provider, various secure connections allowing electronic receipt of data, and transfer of data to partner systems.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 such as, e.g., but not limited to, SDRAM, Flash, a thumb device, a USB device, and interfaces 620, which may allow software and data to be transferred from the removable storage unit 622 to computer system 600.

Exemplary special purpose index construction computer 600 may also include an input device 616 such as, e.g., (but not limited to) a mouse or other pointing device such as a digitizer, and a keyboard or other data entry device (not shown), or an input sensor device 632, such as, e.g., but not limited to, a touch screen, a pressure sensor, an accelerometer, and/or other sensor device such as, e.g., a pressure sensor, a rangefinder, a compass, a camera, accelerometer, gyro, ultrasonic, biometric, secure authentication system, etc.

Exemplary special purpose index construction computer 600 may also include output devices, such as, e.g., (but not limited to) display 630, and display interface 602, or other output device 640. Exemplary special purpose index construction computer 600 may include input/output (I/O) devices such as, e.g., (but not limited to) sensors, touch sensitive, pressure sensitive input systems, accelerometers, and/or communications interface 624, cable 628 and communications path 626, etc. These communications networking devices may include, e.g., but not limited to, a network interface card, and modems (neither are labeled). Communications interface 624 may allow software, and/or financial index data, and/or accounting data, and or index universe data, and/or financial and/or accounting metrics, to be transferred between exemplary special purpose index construction computer system 600 and external devices. Advantageously, exemplary special purpose index construction computer system 600 can be configured to perform various transformations of inputted data into financial screening metrics including metrics of dividend yield metrics and financial health metrics, including respectively, trailing twelve month (TTM) dividend yield, and metrics of financial robustness, including exemplary profitability metrics, distress metrics, and accounting quality metrics, as well as ranking and eliminating based on ranking, as well as banding screening, and weighting and reweighting and/or normalizing and renormalizing.

In this document, the terms “computer program medium” and “computer readable medium” may be used to generally refer to media such as, e.g., but not limited to removable storage drive 614, a hard disk installed in hard disk drive 612, and signals 628, etc. These computer program products may provide software to exemplary special purpose index construction computer system 600. The invention may be directed to such exemplary special purpose index construction computer program products.

Further, FIG. 6B depicts an exemplary embodiment of exemplary subsystem processing of an exemplary Index Construction Calculator Computer device, according to an exemplary embodiment, including an exemplary flow diagram 650, which according to an exemplary embodiment, can begin with an exemplary data model 652, as described further herein. From the data model 652, which can automate the process of constructing an index by beginning with an exemplary universe, and using the APIs and data model, according to an exemplary embodiment, and can using the index calculator computer system 654, can process incoming electronic data from a data source, and can transform the data by electronic data transformer 656, and can then provide the transformed data, in the form of data indicative of an index, for example, or data indicative of asset allocation decision recommendations and can be provided to an electronic decision support system (DSS) 658, and/or computer database management system (DBMS) 660, and/or electronic interactive, graphical user interface (GUI) system 662. Each of the exemplary DSS 658, DBMS 660 and/or EIGUI system 662, can then, using e.g., but not limited to, a cryptographic processor and/or a crypto chip controller, or the like, can then encrypt the data using electronic encryptor 664, which can make use of one or more cryptographic algorithm electronic logic 666, which can include encryption code, a cryptographic combiner, etc., and may be stored in encrypted form, according to an exemplary embodiment, in a computer database storage facility, from computer database storage device 668, and from there the process can continue with use of the cryptographic algorithm electronic logic 670, and electronic decryptor 6772, which can decrypt and/or provide a process for decrypting encrypted data, and/or by providing such data to the DSS 658, the DBMS 660, or the EIGUI 662, if authorized. By using encryption/decryption, certain algorithms can be used, as described above, including, e.g., but not limited to, AES encryption, RSA, PKI, TLS, FTPS, SFTP, etc. and/or other cryptographic algorithms and/or protocols.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An exemplary special purpose index construction algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term exemplary special purpose index construction “processor” may refer to any device or portion of a device that processes electronic data from registers and/or memory to transform that electronic data into other electronic data that may be stored in registers and/or memory. An exemplary special purpose index construction “computing platform” may comprise one or more processors.

Embodiments of the present invention may include exemplary special purpose index construction apparatuses for performing the operations herein. An apparatus may be specially constructed for the desired purposes, selectively activated or reconfigured by an exemplary special purpose index construction program stored in the device in coordination with one or more special purpose data sensors.

In yet another exemplary embodiment, the invention may be implemented using a combination of any of, e.g., but not limited to, hardware, firmware and software, etc.

In one or more embodiments, the present embodiments are embodied in machine-executable instructions. The instructions can be used to cause exemplary special purpose index construction processing device, for example a special-purpose exemplary special purpose index construction processor, which is programmed with the exemplary special purpose index construction instructions, to perform the steps of the present invention. Alternatively, the steps of the present invention can be performed by specific exemplary special purpose index construction hardware components that contain hardwired logic for performing the steps, or by any combination of programmed computer components and custom hardware components. For example, the present invention can be provided as a exemplary special purpose index construction computer program product, as outlined above. In this environment, the embodiments can include a machine-readable medium having exemplary special purpose index construction instructions stored on it. The exemplary special purpose index construction instructions can be used to program any processor or processors (or other electronic devices) to perform a process or method according to the present exemplary embodiments. In addition, the present invention can also be downloaded and stored on a computer program product. Here, the program can be transferred from a remote computer (e.g., a server) to a requesting computer (e.g., a client) by way of data signals embodied in a carrier wave or other propagation medium via a communication link (e.g., a modem or network connection) and ultimately such signals may be stored on the computer systems for subsequent execution).

### Exemplary Communications Embodiments

In one or more embodiments, the present embodiments are practiced in the environment of a computer network or networks. The network can include a private network, or a public network (for example the Internet, as described below), or a combination of both. The network includes hardware, software, or a combination of both.

From a telecommunications-oriented view, the network can be described as a set of exemplary special purpose index construction hardware nodes interconnected by a communications facility, with one or more exemplary special purpose index construction processes (hardware, software, or a combination thereof) functioning at each such node. The processes can inter-communicate and exchange information with one another via communication pathways between them called exemplary special purpose index construction interprocess communication pathways.

On these pathways, appropriate exemplary special purpose index construction communications protocols are used. The distinction between exemplary special purpose index construction hardware and software may not be easily defined, with the same or similar functions capable of being performed with use of either, or alternatives.

An exemplary special purpose index construction computer and/or telecommunications network environment in accordance with the present embodiments may include node, which include may hardware, software, or a combination of hardware and software. The nodes may be interconnected via a communications network. Each node may include one or more processes, executable by processors incorporated into the nodes. A single process may be run by multiple processors, or multiple processes may be run by a single processor, for example. Additionally, each of the nodes may provide an interface point between network and the outside world, and may incorporate a collection of sub-networks.

As used herein, exemplary special purpose index construction “software” processes may include, for example, exemplary special purpose index construction software and/or hardware entities that perform work over time, such as tasks, threads, and intelligent agents. Also, each process may refer to multiple processes, for carrying out instructions in sequence or in parallel, continuously or intermittently.

In an exemplary embodiment, the processes may communicate with one another through exemplary special purpose index construction interprocess communication pathways (not labeled) supporting communication through any communications protocol. The pathways may function in sequence or in parallel, continuously or intermittently. The pathways can use any of the communications standards, protocols or technologies, described herein with respect to a communications network, in addition to standard parallel instruction sets used by many computers.

The nodes may include any entities capable of performing exemplary special purpose index construction processing functions. Examples of such nodes that can be used with the embodiments include computers (such as personal computers, workstations, servers, or mainframes), handheld wireless devices and wireline devices (such as personal digital assistants (PDAs), modem cell phones with processing capability, wireless e-mail devices including BlackBerry™ devices), document processing devices (such as scanners, printers, facsimile machines, or multifunction document machines), or complex entities (such as local-area networks or wide area networks) to which are connected a collection of processors, as described. For example, in the context of the present invention, a node itself can be a wide-area network (WAN), a local-area network (LAN), a private network (such as a Virtual Private Network (VPN)), or collection of networks.

Exemplary special purpose index construction communications between the exemplary special purpose index construction nodes may be made possible by a communications network. A node may be connected either continuously or intermittently with communications network. As an example, in the context of the present invention, a communications network can be a digital communications infrastructure providing adequate bandwidth and information security.

The exemplary special purpose index construction communications network can include wireline communications capability, wireless communications capability, or a combination of both, at any frequencies, using any type of standard, protocol or technology. In addition, in the present embodiments, the communications network can be a private network (for example, a VPN) or a public network (for example, the Internet).

A non-inclusive list of exemplary special purpose index construction wireless protocols and technologies used by a communications network may include BlueTooth™, general packet radio service (GPRS), cellular digital packet data (CDPD), mobile solutions platform (MSP), multimedia messaging (MMS), wireless application protocol (WAP), code division multiple access (CDMA), short message service (SMS), wireless markup language (WML), handheld device markup language (HDML), binary runtime environment for wireless (BREW), radio access network (RAN), and packet switched core networks (PS-CN). Also included are various generation wireless technologies. An exemplary non-inclusive list of primarily wireline protocols and technologies used by a communications network includes asynchronous transfer mode (ATM), enhanced interior gateway routing protocol (EIGRP), frame relay (FR), high-level data link control (HDLC), Internet control message protocol (ICMP), interior gateway routing protocol (IGRP), internetwork packet exchange (IPX), ISDN, point-to-point protocol (PPP), transmission control protocol/internet protocol (TCP/IP), routing information protocol (RIP) and user datagram protocol (UDP). As skilled persons will recognize, any other known or anticipated wireless or wireline protocols and technologies can be used.

The embodiments may be employed across different generations of exemplary special purpose index construction wireless devices. This includes 1G-5G according to present paradigms. 1G refers to the first generation wide area wireless (WWAN) communications systems, dated in the 1970s and 1980s. These devices are analog, designed for voice transfer and circuit-switched, and include AMPS, NMT and TACS. 2G refers to second generation communications, dated in the 1990s, characterized as digital, capable of voice and data transfer, and include HSCSD, GSM, CDMA IS-95-A and D-AMPS (TDMA/IS-136). 2.5G refers to the generation of communications between 2G and 3 G. 3G refers to third generation communications systems recently coming into existence, characterized, for example, by data rates of 144 Kbps to over 2 Mbps (high speed), being packet-switched, and permitting multimedia content, including GPRS, 1.times.RTT, EDGE, HDR, W-CDMA. 4G refers to fourth generation and provides an end-to-end IP solution where voice, data and streamed multimedia can be served to users on an “anytime, anywhere” basis at higher data rates than previous generations, and will likely include a fully IP-based and integration of systems and network of networks achieved after convergence of wired and wireless networks, including computer, consumer electronics and communications, for providing 100 Mbit/s and 1 Gbit/s communications, with end-to-end quality of service and high security, including providing services anytime, anywhere, at affordable cost and one billing. 5G refers to fifth generation and provides a complete version to enable the true World Wide Wireless Web (WWWW), i.e., either Semantic Web or Web 3.0, for example. Advanced technologies may include intelligent antenna, radio frequency agileness and flexible modulation are required to optimize ad-hoc wireless networks.

As noted, each node 102-108 includes one or more exemplary special purpose index construction processes 112, 114, executable by exemplary special purpose index construction processors 110 incorporated into the nodes. In a number of embodiments, the set of exemplary special purpose index construction processes 112, 114, separately or individually, can represent entities in the real world, defined by the purpose for which the invention is used.

Furthermore, the exemplary special purpose index construction processes and processors need not be located at the same physical locations. In other words, each processor can be executed at one or more geographically distant processor, over for example, a LAN or WAN connection. A great range of possibilities for practicing the exemplary special purpose index construction embodiments may be employed, using different networking hardware and software configurations from the ones above mentioned.

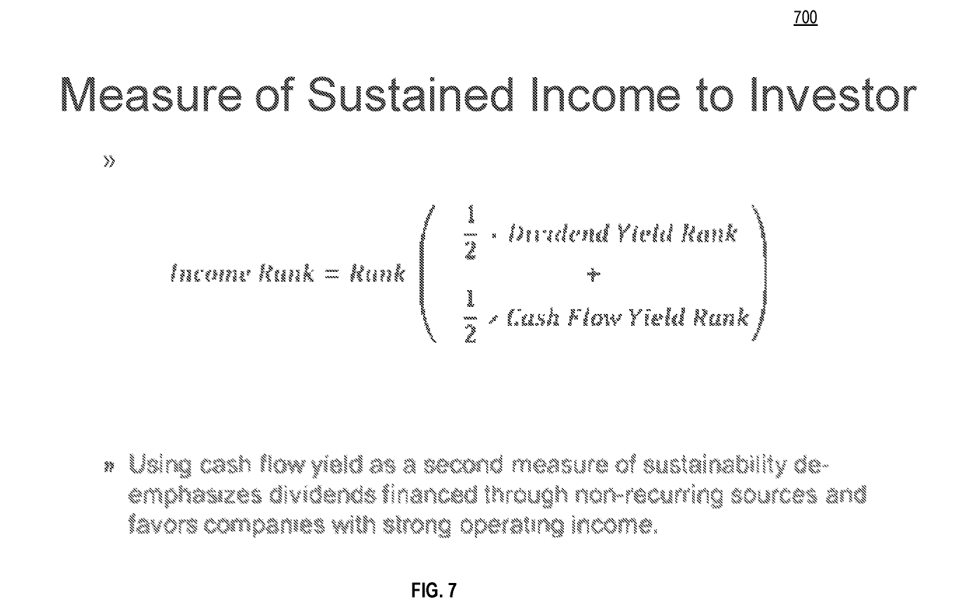

FIG. 7 depicts an exemplary embodiment of an exemplary improved measure of sustained income including an exemplary dividend yield and cash flow yield ranking to determine an exemplary income ranking, discussing using cash flow yield as a second measure of sustainability deemphasizing dividends financed through non-recurring sources and favors companies with strong operating income, according to an exemplary embodiment.

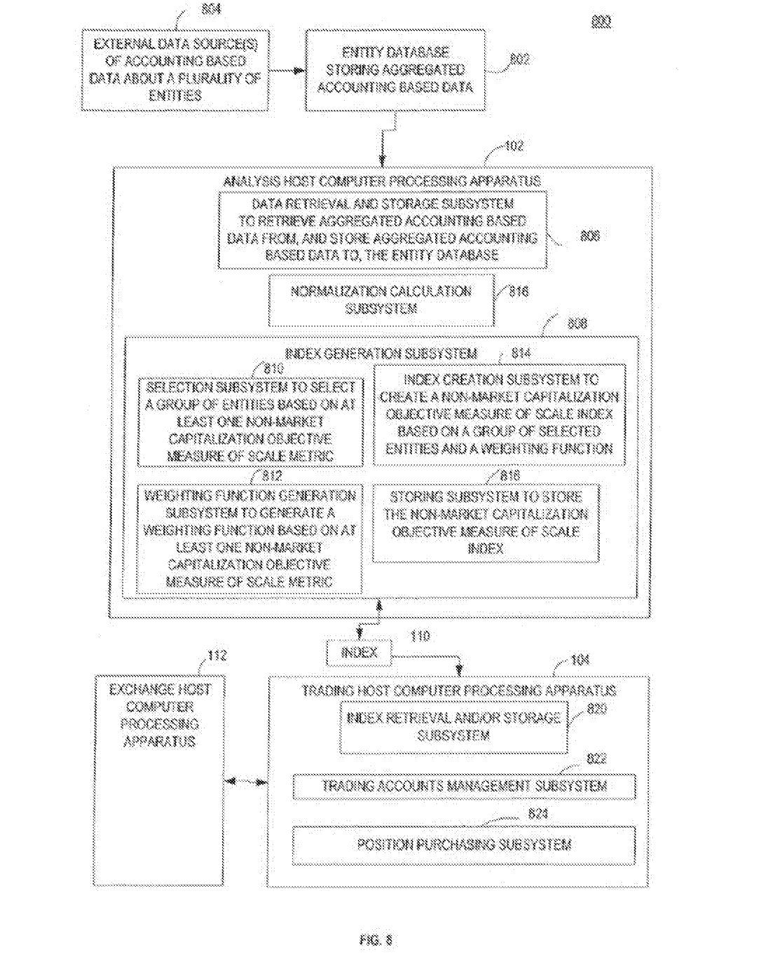

FIG. 8 depicts block diagram 800 of an exemplary system according to an exemplary embodiment. The system may include an exemplary special purpose index construction entity database 802 that, according to an exemplary embodiment, may store aggregated accounting based data and/or other data, metrics, measures, parameters, technical parameters, characteristics and/or factors about a plurality of entities, obtained from an external data source 804. Each exemplary special purpose index construction database 802 entity may have at least one object type associated with the entity. The aggregated accounting based data may include, according to an exemplary embodiment, at least one non-market capitalization, non-price related objective measure of scale and/or size metric associated with each entity. The exemplary special purpose index construction system may include an analysis host exemplary special purpose index construction computer processing apparatus 102 coupled to the exemplary special purpose index construction entity database 802. The exemplary special purpose index construction analysis host computer processing apparatus 102 may include an exemplary special purpose index construction data retrieval and storage subsystem 806, according to an exemplary embodiment, which may retrieve the aggregated accounting based data from the exemplary special purpose index construction entity database and may store the aggregated accounting based data to the exemplary special purpose index construction entity database 802. The exemplary special purpose index construction analysis host computer processing apparatus 102 may include, according to an exemplary embodiment, an exemplary special purpose index construction index generation subsystem 808, which may include, according to an exemplary embodiment, an exemplary special purpose index construction selection subsystem 810 operative to select a group of the entities based on at least one non-market capitalization objective measure of scale or size metric including one or more technical parameters and/or other metrics as discussed further herein; an exemplary special purpose index construction weighting function generation subsystem 812, according to an exemplary embodiment, may be operative to generate a weighting function based on at least one non-market capitalization, non-price related objective measure of scale and/or size metric; an exemplary index creation subsystem 814, according to an exemplary embodiment, may be operative to create a non-market capitalization non-price objective measure of scale and/or size index based on the group of selected entities and/or the exemplary special purpose index construction weighting function; and/or exemplary special purpose index construction storing subsystem 816, according to an exemplary embodiment, operative to store the non-market capitalization, non-price related objective measure of scale and/or size based index, and/or multi-dimensional array of data objects of the exemplary special purpose index construction system. The index or array of data objects may be stored on an exemplary special purpose index construction storage device, in one exemplary embodiment.

According to one exemplary embodiment, the exemplary special purpose index construction system 800 may further include an exemplary special purpose index construction normalization calculation and/or exemplary special purpose index construction computation subsystem 818, operative to normalize entity object data to be stored in the exemplary special purpose index construction entity database 802.

According to another exemplary embodiment, the system 800 may further include an exemplary special purpose index construction trading host computer system 104 which may include, according to an exemplary embodiment, an exemplary special purpose index construction index retrieval subsystem 820 operative to retrieve and/or store an instance of the non-market capitalization, non-price related objective measure of scale and/or size based index, and/or multidimensional array of data objects from a storage device; a exemplary special purpose index construction trading accounts management subsystem 822 operative to manage accounts data relating to a plurality of accounts including positions data, position owner data, and position size data, any data of which may be stored in exemplary special purpose index construction trading accounts database 108; and/or a exemplary special purpose index construction purchasing subsystem 824 operative to purchase from an exchange host system 112 one or more positions for the position owner, according to the index and/or array of data objects.

### Exemplary Process Control System

According to an exemplary embodiment, the system 800 may be used to compute using data objects input via an input/output subsystem, a multi-dimensional array storing database system for storage of a multi-dimensional array computed via a multi-dimensional object array creation subsystem comprising a selection subsystem operative to select one or more objects based on one or more technical parameters, and a weighting subsystem operative to weight the selected one or more objects based on one or more technical parameters, wherein the technical parameters are chosen such that the technical parameters avoid influence of an undesirable predetermined technical criterion and/or criteria, so as to avoid influence of the undesirable predetermined technical criterion and/or criteria. As a result of elimination of the undesirable predetermined technical criterion and/or criteria, the multi-dimensional array selected and/or weighted to avoid influence of the undesirable predetermined technical criterion and/or criteria may as a result perform processing from negative effects from the undesirable predetermined technical criterion and/or criteria. An exemplary embodiment of the selection subsystem may be operative to select objects from a predetermined universe of objects to obtain a subset of the universe, where the selection is based on a technical parameter that is not influenced by the undesirable technical criterion and/or criteria. Following execution of the selection subsystem, according to an exemplary embodiment, an exemplary weighting subsystem may operative to weight the resulting selected objects by a weighted combination of two or more technical weighting criteria, which are not influenced by the undesirable technical criterion and/or criteria. The process may be used for such technical processes as may include, e.g. but are not limited to, industrial automation, production process automation, a manufacturing process, and/or a chemical processing system, among others as described elsewhere, herein.

According to one exemplary embodiment, the weighting subsystem may further compute an algorithmically computed summation of a plurality of weighting factors, the plurality of weighting factors including a first of the plurality of weighting factors, where the first includes a first given computational product of a first object value and a first technical parameter value associated with the first object value, and a second of the plurality of weighting factors, where the second includes a second given computational product of a second object value and a second technical parameter value associated with the second object value, and/or any additional of the plurality of weighting factors, where the any additional includes an additional given computational product of an additional object value and an additional technical parameter value associated with the additional object value.

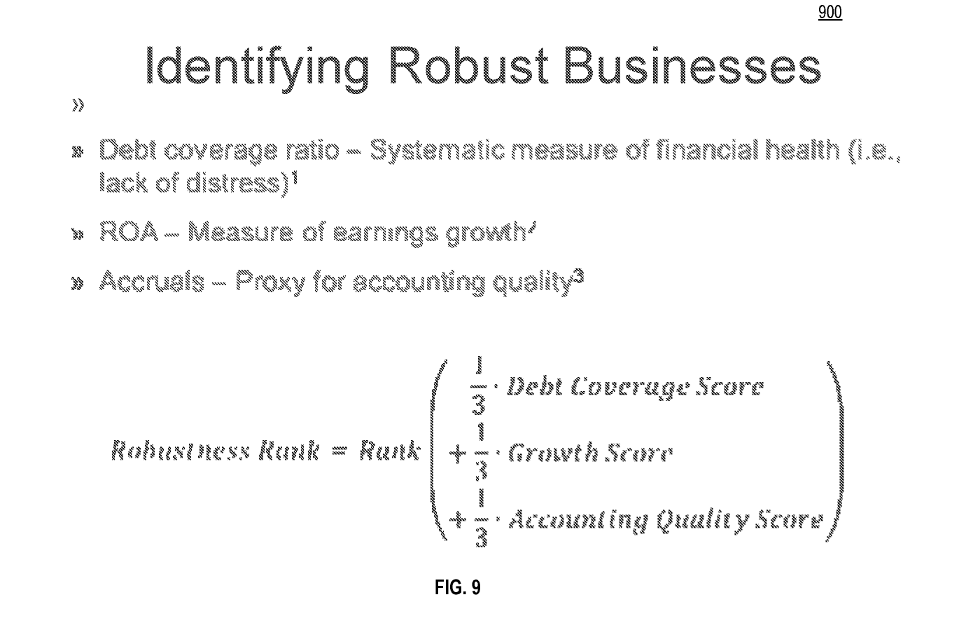

FIG. 9 illustrates an exemplary method of identifying robust businesses via ranking companies based on an exemplary robustness ranking including an exemplary debt coverage score, an exemplary growth score, and an exemplary accounting quality score, according to an exemplary embodiment;

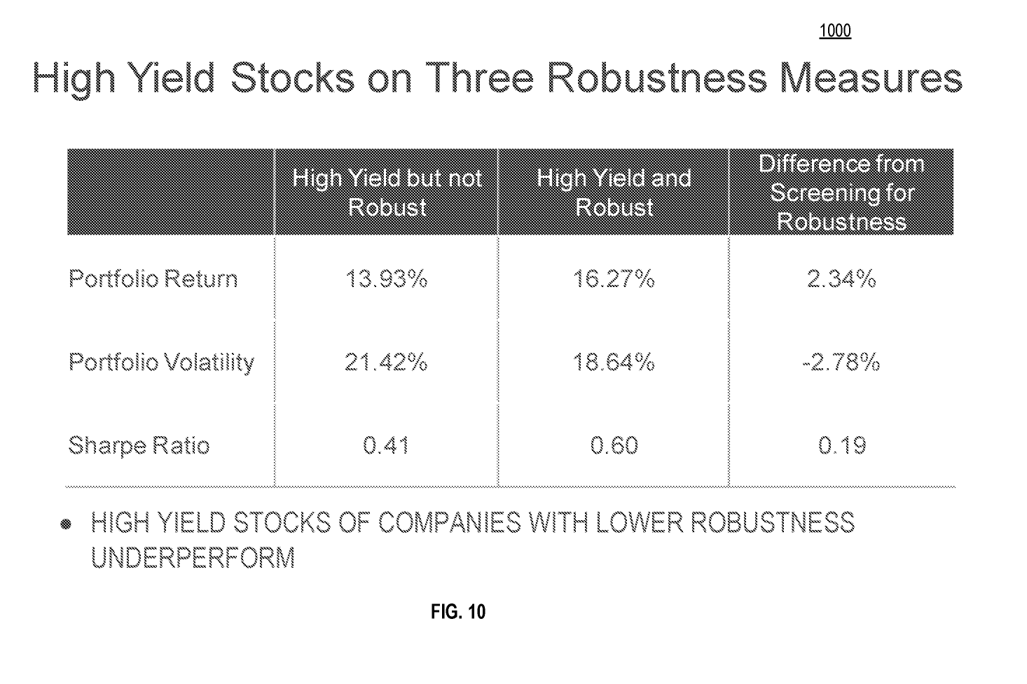

FIG. 10 illustrates an exemplary table discussing high yield stocks on three robustness measures noting a) an exemplary portfolio return, b) an exemplary portfolio volatility, and c) an exemplary Sharpe Ratio for each of i) high yield but not robust, ii) high yield and robust, and iii)difference from screening for robustness, concluding high yield stocks of companies with lower robustness underperform, according to an exemplary embodiment;

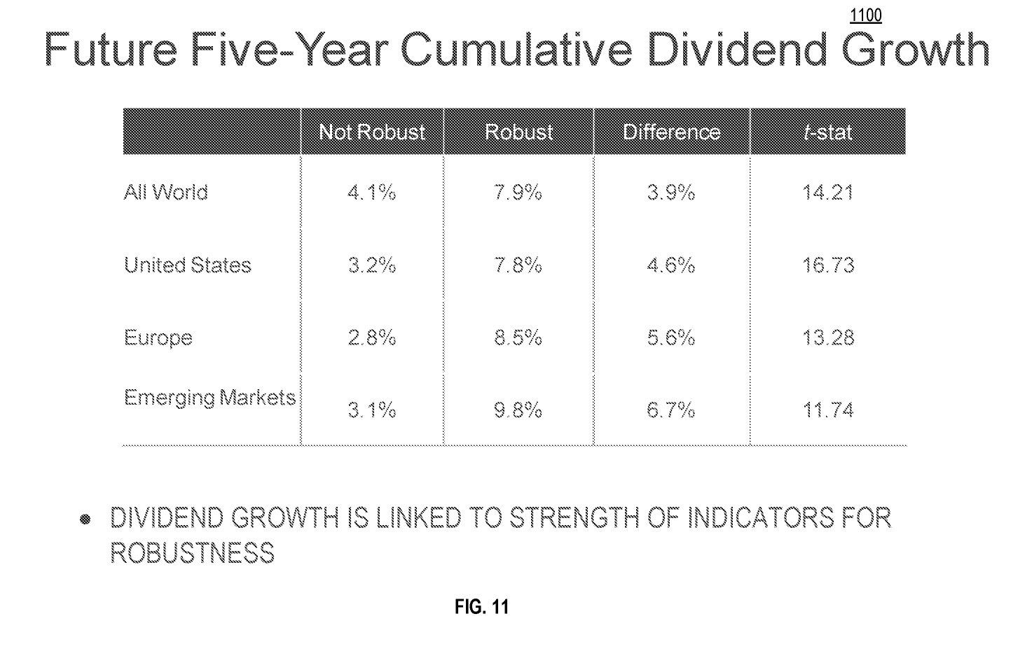

FIG. 11 illustrates an exemplary table discussing future five (5)-year cumulative dividend growth noting for each of a) All World, b) US, c) Europe, and d) Emerging Markets, noting i) Not Robust, ii) robust, iii)difference, and iv) t-stat, concluding dividend growth is linked to strength of indicators for robustness, according to an exemplary embodiment;

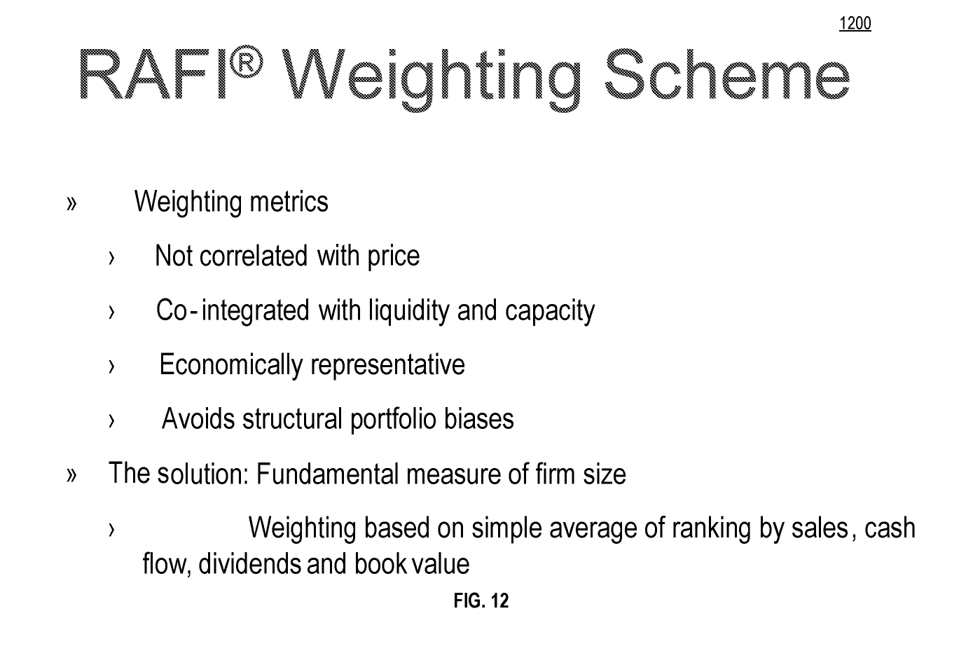

FIG. 12 illustrates an exemplary overview of the RESEARCH AFFILIATES FUNDAMENTAL INDEX (RAFI(R)) weighting scheme noting exemplary weighting metrics including not correlated with price, co-integrated with liquidity and capacity, economically representative, and avoiding structural portfolio biases, and notes the solution is a fundamental measure of firm size including, e.g., but not limited to, weighting based on an exemplary average of ranking by sales, cash flow, dividends, and book value, according to an exemplary embodiment;

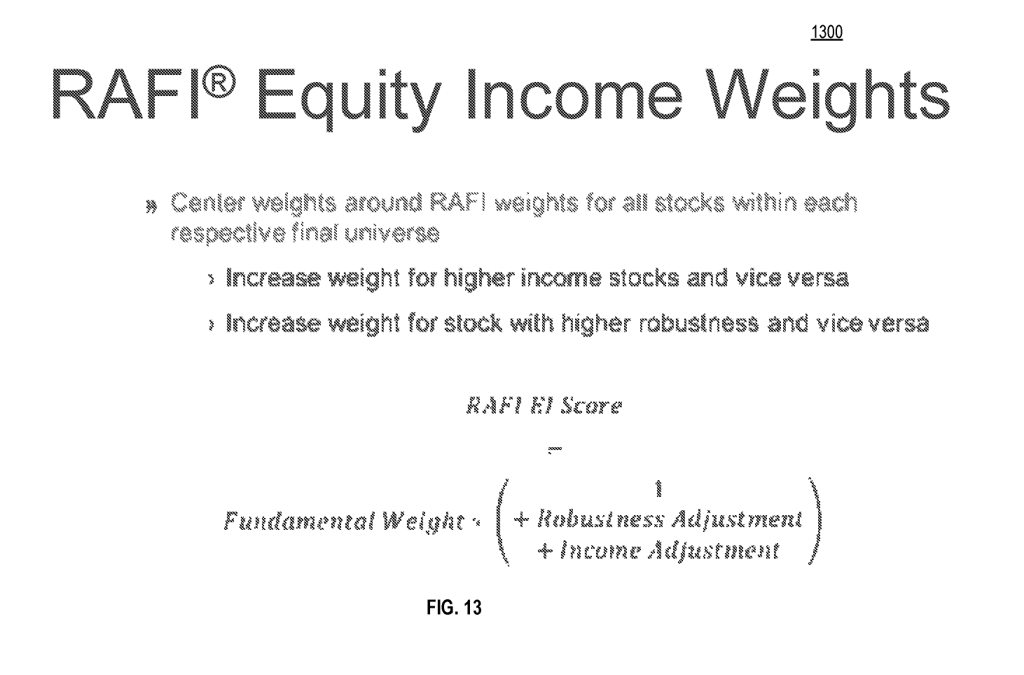

FIG. 13 illustrates an exemplary overview of RAFI Equity Income weights, according to an exemplary embodiment, including centering of weights around RAFI weights for all stocks within each respective final universe, including increasing weight for higher income stocks and vice versa, increasing weight for stocks with higher robustness, and vice versa, including taking a fundamental weight, and multiplying each stock's fundamental weight by 1.0 adjusted by sum of a robustness adjustment, and sum of an income adjustment, according to an exemplary embodiment;

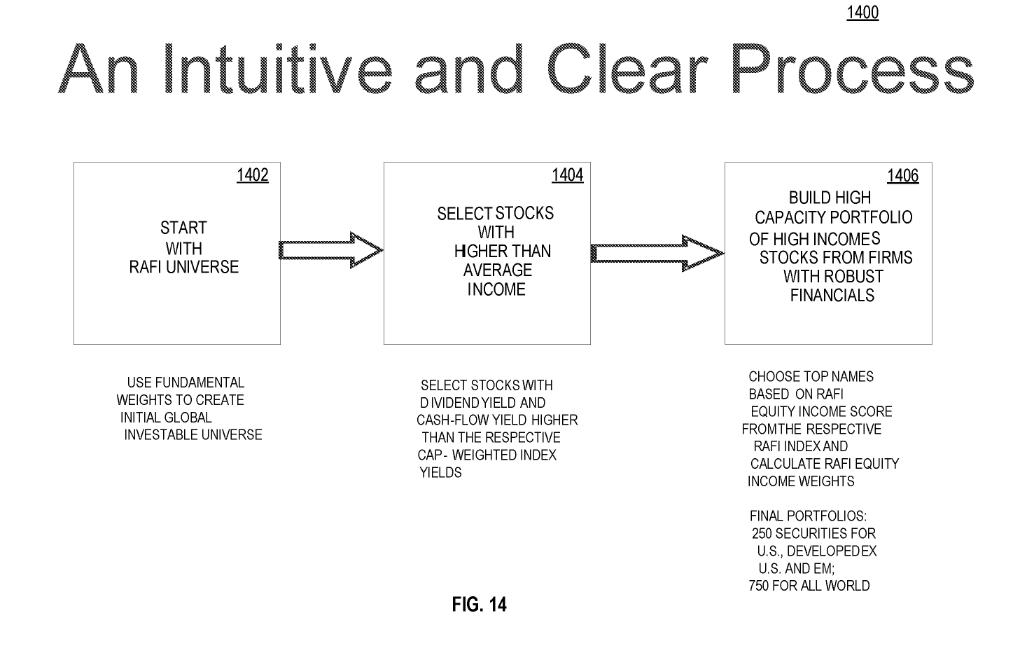

FIG. 14 depicts an exemplary flow diagram 1400 illustrating an intuitive and clear process starting with a RAFI universe, selecting stocks with higher than average income, based on dividend yield and cash-flow yield, and building high capacity portfolios of high income stocks from firms with robust financials by automatically electronically ranking and selecting, according to an exemplary embodiment;

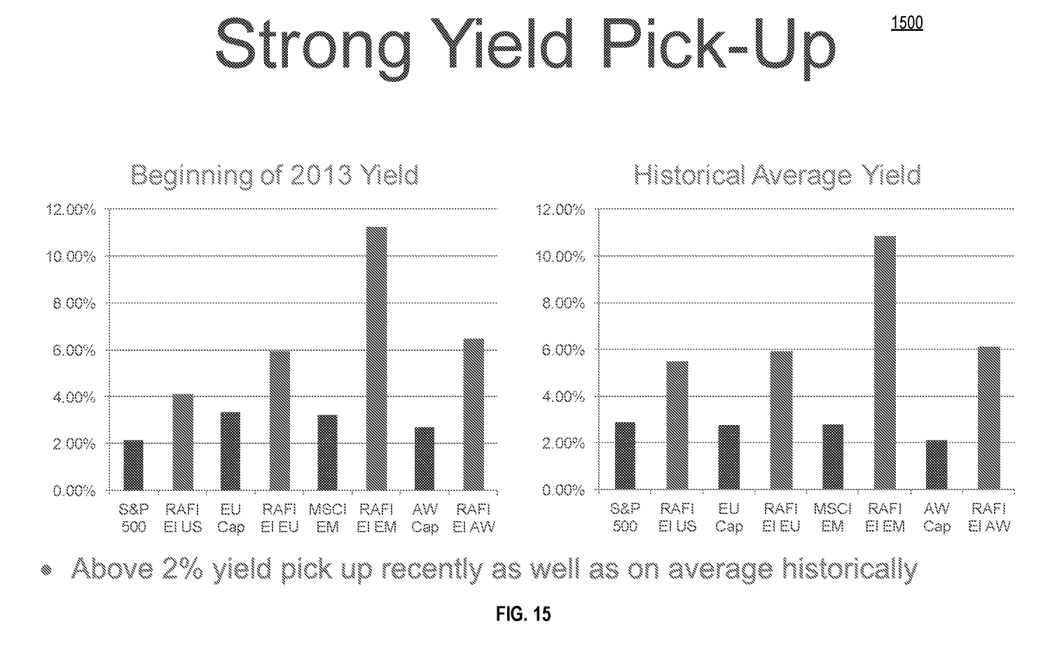

FIG. 15 depicts exemplary charts 1500 illustrating exemplary strong yield pickup, including an above 2% yield pick up recently as well as on average historically, according to an exemplary embodiment.

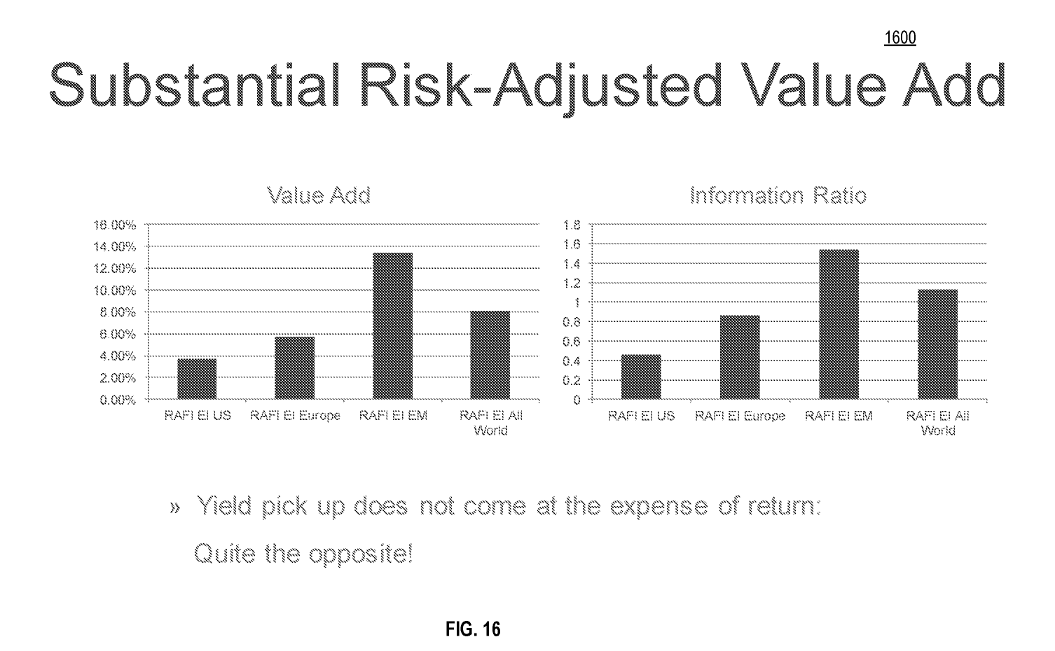

FIG. 16 depicts exemplary charts 1600 illustrating substantial risk-adjusted value add charting exemplary value add, as well as information ratio, noting yield pick up does not come at the expense of return, indeed quite the opposite, according to an exemplary embodiment.

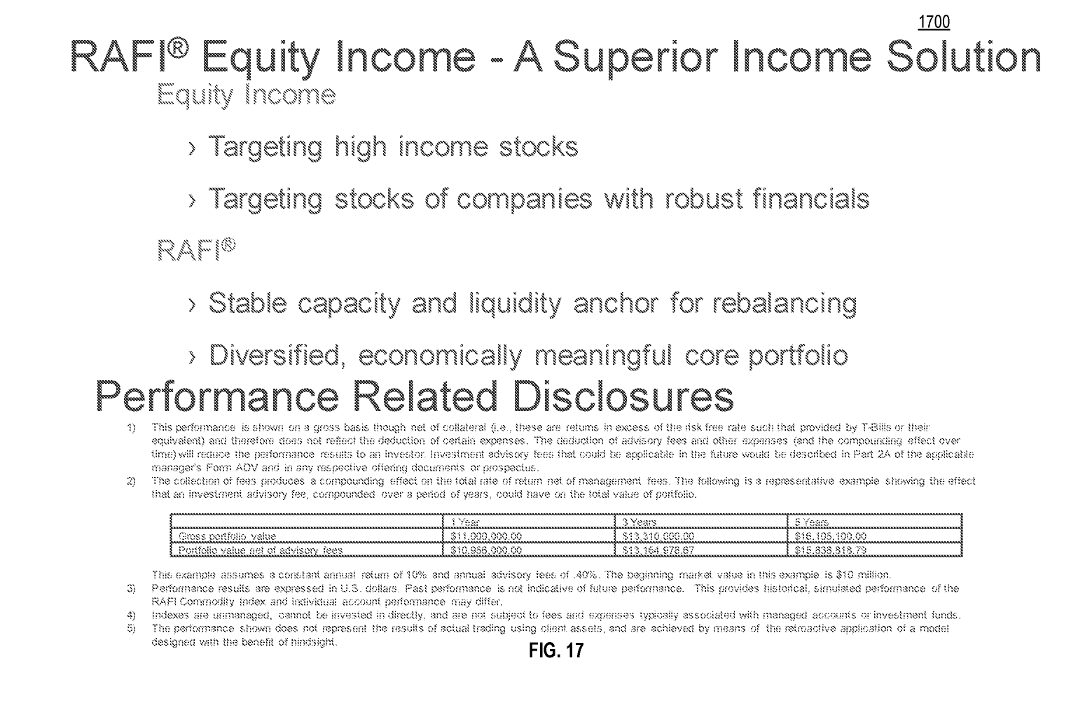

FIG. 17 illustrates how the RAFI equity income solution, according to an exemplary embodiment, provides a superior income solution noting exemplary advantages and also notes various performance related disclosures, according to an exemplary embodiment.

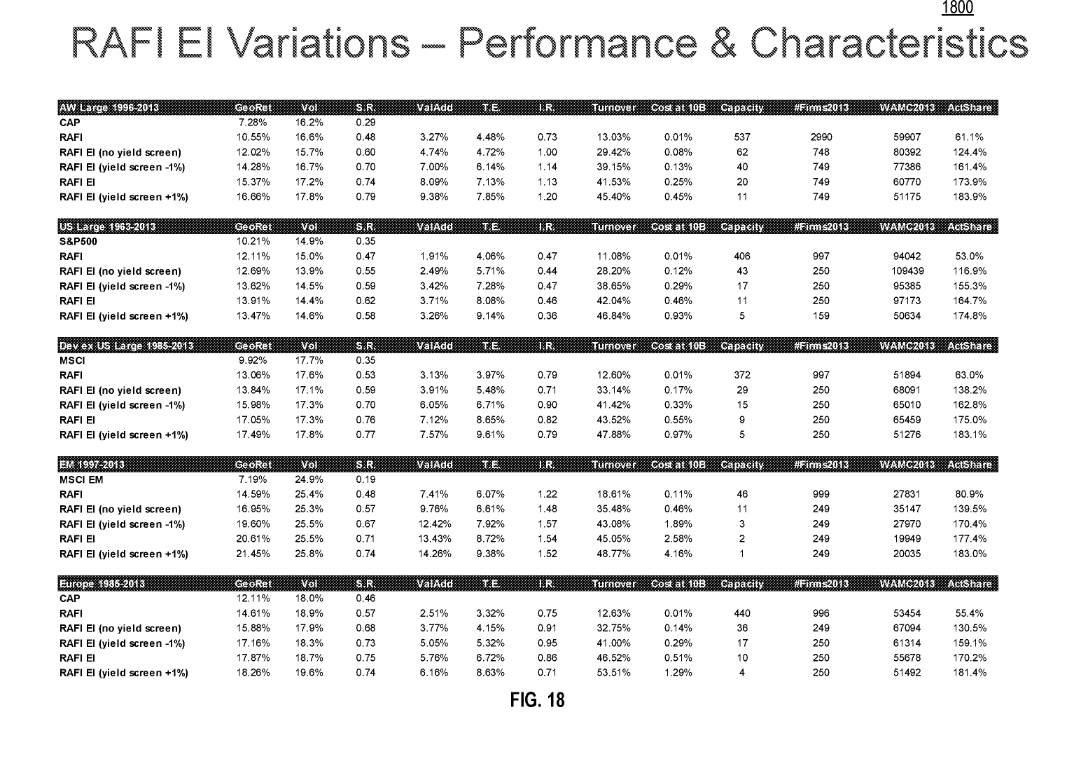

FIG. 18 depicts an exemplary table 1800 illustrating performance and characteristics of various exemplary RAFI Equity Income variations, according to an exemplary embodiment.

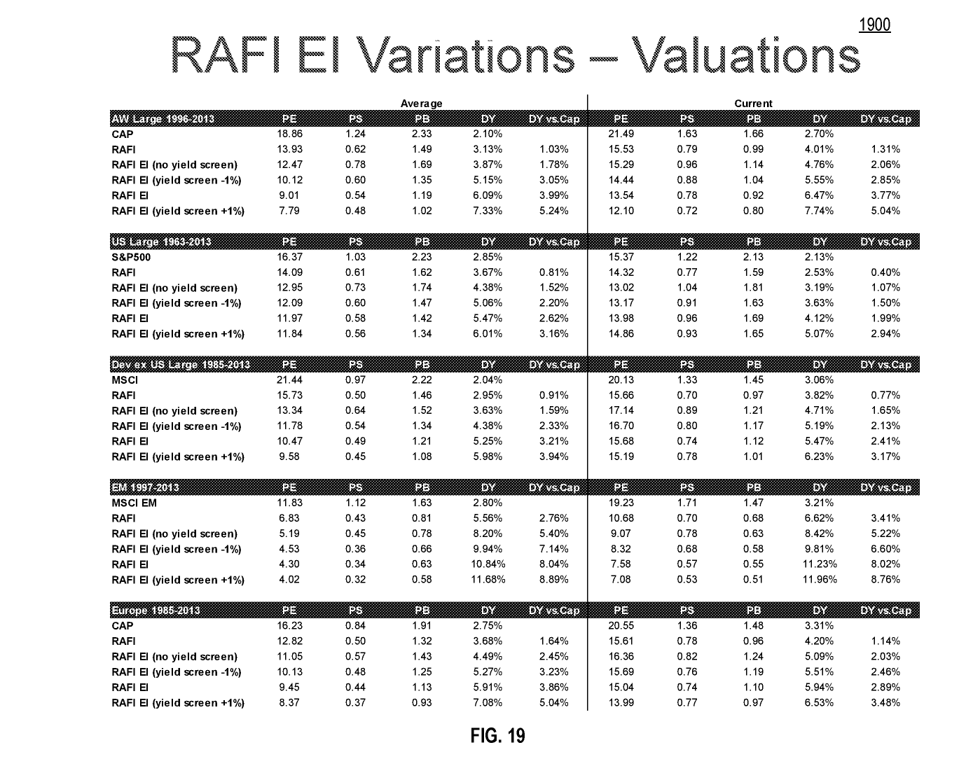

FIG. 19 depicts an exemplary table 1900 illustrating performance and characteristics of various exemplary RAFI Equity Income variations for various valuations, according to an exemplary embodiment.

### Exemplary Data Model

The next section outlines an exemplary Object model and application programming interface (API) of an exemplary core Universe representation data model, as can be used in equity portfolio construction, according to an exemplary embodiment. The model is followed by pseudo code demonstrating how these tools can be used to construct an exemplary (hypothetical, but nonlimiting) fundamental portfolio, starting with an exemplary Bloomberg-sourced exemplary universe and going to final weights. The following description, presents using an exemplary simplified (textual) form of an exemplary standards based way of diagraming classes (see, e.g., a class diagram description overview, be

low).

### Class Diagram Description Overview

As will be apparent to those skilled in software engineering, a class diagram in the Unified Modeling Language (UML) is a type of static structure diagram that describes the structure of a system by showing the system's classes, their attributes, operations (or methods), and the relationships among objects.

The class diagram is the main building block of object-oriented modeling. The class diagram can be used both for general conceptual modeling of the systematics of an application, and for detailed modeling translating the models into programming code. Class diagrams can also be used for data modeling. The classes in a class diagram can represent both the main elements, interactions in the application, and the classes to be programmed.

Classes can be represented by a boxes containing three compartments: 1) A top compartment containing the name of the class. It can be printed in bold and centered, and the first letter is capitalized; 2) The middle compartment can contain the attributes of the class; The attributes can be left-aligned and the first letter can be lowercase; and 3) The bottom compartment can contain operations the class can execute. The bottom can also be left-aligned and the first letter is lowercase.

In the design of a system, a number of classes can be identified and grouped together in a class diagram that can help to determine the static relations between them. With detailed modeling, the classes of the conceptual design can often split into a number of subclasses.

In order to further describe the behavior of systems, class diagrams can be complemented by a state diagram or UML state machine. For further details regarding “class diagrams” the reader is directed to the website https:/en.wikipedia.org/wiki/Class_diagram.

As will be apparent to those skilled in the relevant art, a separator can be also known as a punctuator. Different programming languages can have various separators symbols such as, e.g., but not limited to, “(”, “)”, “{”, “}”, “[”, “]”, “;”, “,”, “.”, etc. The dot separator, “.” can be used to qualify a field in an object or class with a variable or class name, in a language, such as, e.g., but not limited to, Java. The dot separator can also be used to invoke a method for an object or class. For instance, the expression customer1.setName(“John Smith) can be used to invoke the setName method (or function) for a customer object to assign a name John Smith to the customer1 object. A method can represent a function, or process, and can be followed by a pair of parentheses, i.e., “( )”, which may contain one or more arguments, variables, and/or parameters, a plurality of which can be separated pairwise, by a comma, that can be provided as input to the method, and which may be able to pass as output as well, in certain circumstances, and/or syntaxes.

UniverseTable:

A model of a two dimensional table, permitting function-based creation of new columns from previous-column data, and the application of persistent (cumulative) screens.

Methods:

```
            add_percentile_rank_by_group( )
                Adds a percentile rank column
            add_cumulative_by_group( )
                Adds a cumulative weight column, grouping within
categories defined by a field.
            add_normalized_by_group( )
                Adds a normalized weight column, grouping within
categories defined by a field.
            add_column_from_function( )
                Adds a column based on a functional applied to rows.
            add_screen( )
```

Adds a Boolean screen based on a condition applied to rows. A True value denotes continued inclusion. All subsequent processing is only applied to rows True in this (and all previous) screens.

Universe:

A model of the many to one relationship from securities to companies, and tools for processing data in the context of this relationship.

Attributes:

```
co
    a UniverseTable of company data
sec
    a UniverseTable of security data
```

Methods:

parse( ):

Given a data representation of security and/or company data, partitions the data between company-level and security level attributes and loads this data into UniverseTables in .co and .sec attributes.

```
              sec_co_map( )
                  Given a security ID, returns the company ID
              co_sec_record_map( )
                  Given a company ID, returns all associated security
                  data
              co_sec_map( )
                  Given a company ID, returns one or more security
                  IDs
              sec_from_sec index( )
                  Given a secondary security identifier (i.e.,
SEDOL), returns the primary security ID.
              co_from_sec_index( )
                  Given a secondary security identifier (i.e.,
SEDOL), returns the company ID.
              aggregate_from_sec_to_co( )
                  Aggregates a security value to the company level.
              distribute_from_co_to_sec( )
```

Distributes a company value to all securities, optionally in proportion to a security-level value.

Example (pseudo-) code for generating an initial investible universe follows:

# create a universe instance and parse the, e.g., Bloomberg universe
u = Universe( )
u.parse(bloomberg_universe)
# aggregate sec volume to co volume
u.aggregate_from_sec_to_co(‘VOLUME_USD’, lambda values: sum(values))
# screen by company market cap and volume
u.co.add_screen(‘valid_mcap’, lambda row: row[‘MARKET_CAP_USD’] >

min_market_cap)

u.co.add_screen(‘valid_volume’, lambda row: row[‘VOLUME_USD’] > min_volume)
# screen by company attributes
u.co.add_screen(‘valid_industry’,

lambda row: row[‘INDUSTRY_SECTOR’] != ‘Funds’ and
row[‘INDUSTRY_GROUP’] != ‘Investment Companies’)

# derive security attributes
u.sec.add_column_from_function(‘is_partnership’,

lambda row: row[‘SECURITY_TYPE’] in {‘Ltd Part’, ‘Royalty Trst’})

u.sec.add_column_from_function(‘is_mutual_fund’,

lambda row: row[‘SECURITY_TYPE2’] in {‘Mutual Fund’})

# combine to determine valid securities
u.sec.add_column_from_function(‘valid_security’,

lambda row: not row[‘is_partnership’] and not row[‘is_mutual_fund’])

# aggregate valid security: if any security for a company is a valid security, the

company is valid

u.aggregate_from_sec_to_co(‘valid_security’, lambda values: any(values))
# screen in companies with valid securities
u.co.add_screen(‘valid_securites’, lambda row: row[‘valid_security’])
# apply fundamental score to remaining companies
u.co.add_column_from_function(‘f_score’, fundamental_score)
# calculate cumulative weight in six regions
u.co.add_normalized_by_group(‘f_score’, ‘weight_in_group’, group_by=‘Region’)
u.co.add_cumulative_by_group(‘weight_in_group’, ‘cumulative_weight_in_group’,

group_by=‘Region’)

# screen in top weight 86% of weight
u.co.add_screen(‘portfolio_screen’, lambda row: row[‘cumulative_weight_in_group’]

<= .86)

# normalize fundamental score amongst remaining names to produce final weights
u.co.add_normalized_by_group(‘f_score’, ‘weight’, group_by=None)

### Exemplary Encryption of Proprietary Electronic Data Indicative of Financial Index Constituent and Weightings

### Description

Initially confined to the realms of academia and the military, cryptography has gained greater application, thanks to Internet based transmission systems, according to an exemplary embodiment. Uses of cryptography can include, e.g., but not limited to, mobile phones, passwords, SSL, smart cards, and/or DVDs, etc., according to an exemplary embodiment. Cryptography has permeated everyday life, and can be used in exemplary web applications.

According to an exemplary embodiment, cryptography (or crypto) and advanced information security, can be used to protect proprietary financial index and portfolio data. Cryptography can be difficult to get right because there are many approaches to encryption, each with advantages and disadvantages that need to be thoroughly understood by solution architects and developers. In addition, serious cryptography research is typically based in advanced mathematics and number theory, providing a serious barrier to entry. According to an exemplary embodiment,

the proper and accurate implementation of cryptography can be extremely critical to its efficacy. A small mistake in configuration or coding can result in removing a large degree of the protection it affords and rending the crypto implementation useless against serious attacks.

A good understanding of crypto is required to provide a useful system, according to an exemplary embodiment.

### Cryptographic Functions

Cryptographic systems, according to an exemplary embodiment, can provide one or more of the following four example services. It is important to distinguish between these, as some algorithms are more suited to particular tasks, but not to others. When analyzing requirements and risks, one needs to decide which of the four functions should be used to protect the proprietary data, according to an exemplary embodiment.

### Authentication

Using a cryptographic system, according to an exemplary embodiment, one can establish the identity of a remote user (or system). A typical example is the SSL certificate of a web server providing proof to the user device that user device is connected to the correct server, according to an exemplary embodiment.

The identity is not of the user, but of the cryptographic key of the user. Having a less secure key lowers the trust one can place on the identity, according to an exemplary embodiment.

### Non-Repudiation

The concept of non-repudiation is particularly important for financial or e-commerce applications, according to an exemplary embodiment. Often, cryptographic tools are required to prove that a unique user has made a transaction request, according to an exemplary embodiment. It must not be possible for the user to refute his or her actions, according to an exemplary embodiment.

For example, a customer can request a transfer of money from her account to be paid to another account, according to an exemplary embodiment. Later, she claims never to have made the request and demands the money be refunded to the account. If one has non-repudiation through cryptography, one can prove—usually through digitally signing the transaction request, that the user authorized the transaction.

### Confidentiality

More commonly, the biggest concern can be to keep information private, according to an exemplary embodiment. Cryptographic systems, according to an exemplary embodiment, have been developed to function in this capacity. Whether it be passwords sent during a log on process, or storing confidential proprietary financial data in a database, encryption can assure that only users who have access to the appropriate key can get access to the proprietary data.

### Integrity

One can use cryptography, according to an exemplary embodiment, to provide a means to ensure data is not viewed or altered during storage or transmission. Cryptographic hashes for example, can safeguard data by providing a secure checksum, according to an exemplary embodiment.

### Cryptographic Algorithms

Various types of cryptographic systems exist that have different strengths and weaknesses, according to an exemplary embodiment. Typically, the exemplary cryptographic systems can be divided into two classes; 1) those that are strong, but slow to run, and 2) those that are quick, but less secure. Most often a combination of the two approaches can be used, according to an exemplary embodiment (e.g.: secure socket layer (SSL)), whereby we establish the connection with a secure algorithm, and then if successful, encrypt the actual transmission with the weaker, but much faster algorithm.

### Symmetric Cryptography

Symmetric Cryptography, according to an exemplary embodiment, is the most traditional form of cryptography. In a symmetric cryptosystem, the involved parties share a common secret (password, pass phrase, or key), according to an exemplary embodiment. Data can be encrypted and decrypted using the same key, according to an exemplary embodiment. These symmetric cryptography algorithms tend to be comparatively fast, but the algorithms cannot be used unless the involved parties have already exchanged keys, according to an exemplary embodiment. Any party possessing a specific key can create encrypted messages using that key as well as decrypt any messages encrypted with the key, according to an exemplary embodiment. In systems involving a number of users who each need to set up independent, secure communication channels, symmetric cryptosystems can have practical limitations due to the requirement to securely distribute and manage large numbers of keys, according to an exemplary embodiment.

Common examples of symmetric algorithms include, e.g., but not limited to, DES, 3DES and/or AES, etc. The 56-bit keys used in DES are short enough to be easily brute-forced by modern hardware and DES should no longer be used, according to an exemplary embodiment. Triple DES (or 3DES) uses the same algorithm, applied three times with different keys giving it an effective key length of 128 bits, according to an exemplary embodiment. Due to the problems using the DES algorithm, the United States National Institute of Standards and Technology (NIST) hosted a selection process for a new algorithm. The winning algorithm was Rijndael and the associated cryptosystem is now known as the Advanced Encryption Standard or AES, according to an exemplary embodiment. For most applications 3DES, according to an exemplary embodiment, is acceptably secure at the current time, but for most new applications it is advisable to use AES, according to an exemplary embodiment.

### Asymmetric Cryptography (Also Called Public/Private Key Cryptography)

Asymmetric algorithms, according to an exemplary embodiment, use two keys, one to encrypt the data, and either key to decrypt. These inter-dependent keys are generated together, according to an exemplary embodiment. One key is labeled the Public key and is distributed freely, according to an exemplary embodiment. The other key is labeled the Private Key and must be kept hidden, according to an exemplary embodiment. Often referred to as Public/Private Key Cryptography, these cryptosystems can provide a number of different functions depending on how they are used, according to an exemplary embodiment.

The most common usage of asymmetric cryptography is to send messages with a guarantee of confidentiality, according to an exemplary embodiment. If User A wanted to send a message to User B, User A would get access to User B's publicly-available Public Key, according to an exemplary embodiment. The message is then encrypted with this key and sent to User B, according to an exemplary embodiment. Because of the cryptosystem's property that messages encoded with the Public Key of User B can only be decrypted with User B's Private Key, only User B can read the message, according to an exemplary embodiment.

Another usage scenario is one where User A wants to send User B a message and wants User B to have a guarantee that the message was sent by User A, according to an exemplary embodiment. In order to accomplish this, User A can encrypt the message with their Private Key, according to an exemplary embodiment. The message can then only be decrypted using User A's Public Key, according to an exemplary embodiment. This can guarantee that User A created the message because User A is then the only entity who had access to the Private Key required to create a message that can be decrypted by User A's Public Key, according to an exemplary embodiment. This is essentially a digital signature guaranteeing that the message was created by User A, according to an exemplary embodiment.

A Certificate Authority (CA), whose public certificates are installed with browsers or otherwise commonly available, may also digitally sign public keys or certificates, according to an exemplary embodiment. One can authenticate remote systems or users via a mutual trust of an issuing CA, according to an exemplary embodiment. One can trust their ‘root’ certificates, according to an exemplary embodiment, which in turn authenticates the public certificate presented by the server.

PGP and SSL are prime examples of systems implementing asymmetric cryptography, using RSA and/or other algorithms, according to an exemplary embodiment.

### Hashes

Hash functions, according to an exemplary embodiment, take some data of an arbitrary length (and possibly a key or password) and generate a fixed-length hash based on this input. Hash functions used in cryptography have the property that it can be easy to calculate the hash, but difficult or impossible to re-generate the original input if only the hash value is known, according to an exemplary embodiment. In addition, hash functions useful for cryptography have the property that it is difficult to craft an initial input such that the hash will match a specific desired value, according to an exemplary embodiment.

MD5 and SHA-1 are common hashing algorithms, according to an exemplary embodiment. These algorithms are considered weak and are likely to be replaced in due time after a process similar to the AES selection, according to an exemplary embodiment. New applications should consider using SHA-256 instead of these weaker algorithms, according to an exemplary embodiment.

### Key Exchange Algorithms

There are also key exchange algorithms (such as Diffie-Hellman for SSL), according to an exemplary embodiment. These key exchange algorithms can allow use to safely exchange encryption keys with an unknown party, according to an exemplary embodiment.

### Algorithm Selection

As modern cryptography relies on being computationally expensive to break, according to an exemplary embodiment, specific standards can be set for key sizes that can provide assurance that with today's technology and understanding, it will take too long to decrypt a message by attempting all possible keys, according to an exemplary embodiment.

Therefore, we need to ensure that both the algorithm and the key size are taken into account when selecting an algorithm, according to an exemplary embodiment.

### How to Determine if Proprietary Financial Data is Vulnerable

Proprietary encryption algorithms, according to an exemplary embodiment, cannot be trusted (absent reliance on sound mathematics) as they typically rely on ‘security through. These algorithms should be avoided if possible, according to an exemplary embodiment.

Specific algorithms to avoid:

MD, according to an exemplary embodiment, has recently been found less secure than previously thought. While still safe for most applications such as hashes for binaries made available publicly, secure applications should migrate away from this algorithm.

SHA-0 has been conclusively broken, according to an exemplary embodiment. It should no longer be used for any sensitive applications.

SHA-1 has been reduced in strength, according to an exemplary embodiment, and it is encouraged that one consider a migration to SHA-256, which implements a larger key size.

DES was once the standard crypto algorithm for encryption, according to an exemplary embodiment; a normal desktop machine can now break it. AES, according to an exemplary embodiment, is a preferred symmetric algorithm.

Cryptography is a constantly changing field. As new discoveries in cryptanalysis are made, older algorithms will be found unsafe, according to an exemplary embodiment. In addition, as computing power increases, the feasibility of brute force attacks will render other cryptosystems or the use of certain key lengths unsafe, according to an exemplary embodiment. Standard bodies such as NIST will provide recommendations for future preferred algorithms, according to an exemplary embodiment.

Specific applications, such as banking transaction systems, and certain financial data systems can have specific requirements for algorithms and key sizes.

### How to Protect Proprietary Financial Data

Assuming one has chosen an open, standard algorithm, the following recommendations should be considered when reviewing algorithms, according to an exemplary embodiment:

### Symmetric:

Key sizes of 128 bits (standard for SSL) are sufficient for most applications, according to an exemplary embodiment

Consider 168 or 256 bits for secure systems such as large financial transactions, and proprietary data, according to an exemplary embodiment

Symmetric-key encryption protocols should include message authentication, according to an exemplary embodiment

Always Encrypt first, and then authenticate, appending a message authentication code (MAC).

### Asymmetric:

The difficulty of cracking a 2048 bit key, according to an exemplary embodiment, compared to a 1024 bit key is far more than the twice one might expect. Do not use excessive key sizes unless you know that you need them. Bruce Schneier in 2002 recommended the following key lengths for circa 2005 threats, according to an exemplary embodiment: Key sizes of 1280 bits are sufficient for most personal applications; 1536 bits should be acceptable today for most secure applications; and 2048 bits should be considered for highly protected applications, according to an exemplary embodiment.

### Hashes:

Hash sizes of 128 bits (standard for SSL) are sufficient for most applications, according to an exemplary embodiment

Consider 168 or 256 bits for secure systems, as many hash functions are currently being revised, according to an exemplary embodiment.

NIST and other standards bodies can provide up to date guidance on suggested key sizes, according to an exemplary embodiment.

Design Application to Cope with New Hashes and Algorithms

### Key Storage

As highlighted above, crypto relies on keys to assure a user's identity, provide confidentiality and integrity as well as non-repudiation, according to an exemplary embodiment. It is vital that the keys are adequately protected, according to an exemplary embodiment. Should a key be compromised, it can no longer be trusted, according to an exemplary embodiment.

Any system that has been compromised in any way should have all its cryptographic keys replaced, according to an exemplary embodiment.

### How to Determine if Data is Vulnerable

Unless one is using hardware cryptographic devices, keys will most likely be stored as binary files on the system providing the encryption, according to an exemplary embodiment.

Can one export the private key or certificate from the store?

Are any private keys or certificate import files (usually in PKCS #12 format) on the file system? Can they be imported without a password?

Keys are often stored in code. This is a bad idea, as it means you will not be able to easily replace keys should they become compromised.

### How to Protect Proprietary Financial Data

Cryptographic keys, according to an exemplary embodiment should be protected as much as is possible with file system permissions, according to an exemplary embodiment. They should be read only and only the application or user directly accessing them should have these rights, according to an exemplary embodiment.

Private keys, according to an exemplary embodiment should be marked as not exportable when generating the certificate signing request.

Once imported into the key store (e.g., but not limited to, CryptoAPI, Certificates snap-in, Java Key Store, etc.), the private certificate import file obtained from the certificate provider should be safely destroyed from front-end systems, according to an exemplary embodiment. This file, according to an exemplary embodiment, should be safely stored in a safe until required (such as, e.g., but not limited to, installing or replacing a new front end server).

Host based intrusion systems, according to an exemplary embodiment, should be deployed to monitor access of keys. At the very least, changes in keys should be monitored, according to an exemplary embodiment.

Applications should log any changes to keys, according to an exemplary embodiment.

Pass phrases used to protect keys should be stored in physically secure places, according to an exemplary embodiment; in some environments, it may be necessary to split the pass phrase or password into two components such that two people will be required to authorize access to the key, according to an exemplary embodiment. These physical, processes should be tightly monitored and controlled, according to an exemplary embodiment.

Storage of keys within source code or binaries should be avoided, according to an exemplary embodiment. This not only has consequences if developers have access to source code, but key management will be almost impossible, according to an exemplary embodiment.

In a typical web environment, web servers themselves can need permission to access the key, according to an exemplary embodiment. This has obvious implications that other web processes or malicious code may also have access to the key, according to an exemplary embodiment. In these cases, it is vital to minimize the functionality of the system and application requiring access to the keys, according to an exemplary embodiment.

For interactive applications, a sufficient safeguard is to use a pass phrase or password to encrypt the key when stored on disk, according to an exemplary embodiment. This can require the user to supply a password on startup, but can mean the key can safely be stored in cases where other users may have greater file system privileges, according to an exemplary embodiment.

Storage of keys in hardware crypto devices, according to an exemplary embodiment, is another approach.

### Protecting Proprietary Financial Data at Different Levels of the OSI Model

One has the possibility to encrypt or otherwise protect data at different levels of the OSI stack, according to an exemplary embodiment. Choosing the right place for this to occur can involve looking at both security as well as resource requirements, according to an exemplary embodiment.

Application: at this level, the actual application can perform the encryption or other crypto function, according to an exemplary embodiment. This is the most desirable, but can place additional strain on resources and create unmanageable complexity, according to an exemplary embodiment. Encryption can be performed typically through an API such as the OpenSSL toolkit (www.openssl.com) or operating system provided crypto functions, according to an exemplary embodiment.

An example could be an S/MIME encrypted email, which, according to an exemplary embodiment, can be transmitted as encoded text within a standard email. No changes to intermediate email hosts can be necessary, according to an exemplary embodiment, to transmit the message because one does not require a change to the protocol itself

Protocol: at this layer, the protocol provides the encryption service, according to an exemplary embodiment. Most commonly, this is seen in HTTPS, using SSL encryption to protect sensitive web traffic. The application can no longer need to implement secure connectivity, according to an exemplary embodiment. However, this does not mean the application has a free ride, according to an exemplary embodiment. SSL can require careful attention when used for mutual (client-side) authentication, as there can be two different session keys, one for each direction, according to an exemplary embodiment. Each should be verified before transmitting sensitive data, according to an exemplary embodiment.

Attackers and penetration testers love SSL to hide malicious requests (such as injection attacks for example), according to an exemplary embodiment. Content scanners are most likely unable to decode the SSL connection, letting it pass to the vulnerable web server, according to an exemplary embodiment.

Network: below the protocol layer, according to an exemplary embodiment, we can use technologies such as Virtual Private Networks (VPN) to protect data. This has many incarnations, the most popular being IPsec (Internet Protocol v6 Security), typically implemented as a protected ‘tunnel’ between two gateway routers, according to an exemplary embodiment. Neither the application nor the protocol needs to be crypto aware—all traffic is encrypted regardless, according to an exemplary embodiment.

Possible issues at this level, according to an exemplary embodiment, are computational and bandwidth overheads on network devices.

### Reversible Authentication Tokens

Today's web servers, according to an exemplary embodiment, can typically deal with large numbers of users. Differentiating between them is often done through cookies or other session identifiers, according to an exemplary embodiment. If these session identifiers use a predictable sequence, an attacker need only generate a value in the sequence in order to present a seemingly valid session token, according to an exemplary embodiment.

This can occur at a number of places; the network level for TCP sequence numbers, or right through to the application layer with cookies used as authenticating tokens, according to an exemplary embodiment.

### How to Determine if Proprietary Financial Data is Vulnerable

Any deterministic sequence generator can likely be vulnerable, according to an exemplary embodiment.

### How to Protect a Financial System

When generating secure authentication tokens, according to an exemplary embodiment, ensure there is no way to predict their sequence, according to an exemplary embodiment. In other words: use true random numbers, according to an exemplary embodiment.

It could be argued that computers can not generate true random numbers, but using new techniques such as reading mouse movements and key strokes to improve entropy has significantly increased the randomness of random number generators, according to an exemplary embodiment. It is critical that one does not try to implement this on one's own; use of existing, proven implementations is highly desirable, according to an exemplary embodiment.

Most operating systems include functions to generate random numbers that can be called from almost any programming language, according to an exemplary embodiment.

Windows & .NET: On Microsoft platforms including .NET, it is recommended to use the inbuilt CryptGenRandom function (http://msdn.microsoft.com/library/default.asp?url=/library/en-us/seccrypto/security/cryptgenrandom.asp), according to an exemplary embodiment.

Unix: For all Unix based platforms, OpenSSL, according to an exemplary embodiment, is an excellent option (http://www.openssl.org/). It features tools and API functions, according to an exemplary embodiment, to generate random numbers. On some platforms, /dev/urandom is a suitable source of pseudo-random entropy, according to an exemplary embodiment.

PHP: mt_rand( ) uses a Mersenne Twister, but is nowhere near as good as CryptoAPI's secure random number generation options, OpenSSL, or /dev/urandom which is available on many Unix variants. mt_rand( ) has been noted to produce the same number on some platforms—test prior to deployment. Use of rand( ) is discouraged, as it is very weak, according to an exemplary embodiment.

Java: java.security. SecureRandom within the Java Cryptography Extension (JCE) provides secure random numbers, according to an exemplary embodiment. This should be used in preference to other random number generators.

ColdFusion: ColdFusion MX 7 leverages the JCE java.security, according to an exemplary embodiment. SecureRandom class of the underlying JVM can be the pseudo random number generator (PRNG), according to an exemplary embodiment.

### Encryption Summary

Cryptography is one of pillars of information security, according to an exemplary embodiment. Cryptography usage and propagation has exploded due to the Internet and many areas of computing. Crypto, according to an exemplary embodiment, can be used for:

Remote access such as IPsec VPN

Certificate based authentication

Securing confidential or sensitive information

Obtaining non-repudiation using digital certificates

Online orders and payments

Email and messaging security such as S/MIME

A web application can implement cryptography at multiple layers according to an exemplary embodiment: application, application server or runtime (such as .NET), operating system and hardware. Selecting an optimal approach, according to an exemplary embodiment, can require a good understanding of application requirements, the areas of risk, and the level of security strength it might require, flexibility, cost, etc., according to an exemplary embodiment.

Although cryptography is not a panacea, the majority of security breaches do not come from brute force computation but from exploiting mistakes in implementation. The strength of a cryptographic system is measured in key length, according to an exemplary embodiment. Using a large key length and then storing the unprotected keys on the same server eliminates most of the protection benefit gained, according to an exemplary embodiment. Besides the secure storage of keys, another classic mistake is engineering custom cryptographic algorithms (to generate random session ids for example), according to an exemplary embodiment. Many web applications were successfully attacked because the developers thought they could create their crypto functions, according to an exemplary embodiment.

### Advanced Encryption Standard (AES)

Advanced Encryption Standard (AES), also known as Rijndael (its original name), is a specification for encryption of electronic data established by the U.S. National Institute of Standards and Technology (NIST) in 2001, according to an exemplary embodiment.

AES is based on the Rijndael cipher developed by two Belgian cryptographers, Joan Daemen and Vincent Rijmen, who submitted a proposal to NIST during the AES selection process. Rijndael is a family of ciphers with different key and block sizes, according to an exemplary embodiment.

For AES, NIST selected three members of the Rijndael family, each with a block size of 128 bits, but three different key lengths: 128, 192 and 256 bits, according to an exemplary embodiment.

AES has been adopted by the U.S. government and is now used worldwide, according to an exemplary embodiment. It supersedes the Data Encryption Standard (DES), which was published in 1977, according to an exemplary embodiment. The algorithm described by AES is a symmetric-key algorithm, meaning the same key is used for both encrypting and decrypting the data, according to an exemplary embodiment.

In the United States, AES was announced by the NIST as U.S. FIPS PUB 197 (FIPS 197) on November 26, 2001. This announcement followed a five-year standardization process in which fifteen competing designs were presented and evaluated, before the Rijndael cipher was selected as the most suitable (see Advanced Encryption Standard process for more details).

AES became effective as a federal government standard on May 26, 2002 after approval by the Secretary of Commerce. AES is included in the ISO/IEC 18033-3 standard. AES is available in many different encryption packages, and is the first (and only) publicly accessible cipher approved by the National Security Agency (NSA) for top secret information when used in an NSA approved cryptographic module.

The name Rijndael (Dutch pronunciation: ['rεinda:l]) is a play on the names of the two inventors (Joan Daemen and Vincent Rijmen).

Attacks have been published that are computationally faster than a full brute force attack, though none as of 2013 are computationally feasible, according to an exemplary embodiment.

For AES-128, the key can be recovered with a computational complexity of 2126.1 using the biclique attack. For biclique attacks on AES-192 and AES-256, the computational complexities of 2189.7 and 2254.4 respectively apply. Related-key attacks can break AES-192 and AES-256 with complexities 2176 and 299.5, respectively, according to an exemplary embodiment.

Key sizes of 128, 160, 192, 224, and 256 bits are supported by the Rijndael algorithm, but only the 128, 192, and 256-bit key sizes are specified in the AES standard, according to an exemplary embodiment.

Block sizes of 128, 160, 192, 224, and 256 bits are supported by the Rijndael algorithm, but only the 128-bit block size is specified in the AES standard, according to an exemplary embodiment.

The structure of the AES cipher is a substitution-permutation network, according to an exemplary embodiment.

Cipher detail

| | |
|---|---|
| Key sizes | 128, 192 or 256 bits |
| Block sizes | 128 bits |
| Rounds | 10, 12 or 14 (depending on key size) |

### Substitution-Permutation Network

In cryptography, an SP-network, or substitution-permutation network (SPN), is a series of linked mathematical operations used in block cipher algorithms such as AES (Rijndael), 3-Way, Grasshopper, PRESENT, SAFER, SHARK, and Square, according to an exemplary embodiment.

Such a network takes a block of the plaintext and the key as inputs, and applies several alternating “rounds” or “layers” of substitution boxes (S-boxes) and permutation boxes (P-boxes) to produce the ciphertext block, according to an exemplary embodiment. The S-boxes and P-boxes transform (sub-)blocks of input bits into output bits, according to an exemplary embodiment. It is common for these transformations to be operations that are efficient to perform in hardware, such as exclusive or (XOR) and bitwise rotation, according to an exemplary embodiment. The key is introduced in each round, usually in the form of “round keys” derived from it, according to an exemplary embodiment. (In some designs, the S-boxes themselves can depend on the key.)

Decryption, according to an exemplary embodiment, is done by simply reversing the process (using the inverses of the S-boxes and P-boxes and applying the round keys in reversed order).

An S-box substitutes a small block of bits (the input of the S-box) by another block of bits (the output of the S-box), according to an exemplary embodiment. This substitution should be one-to-one, to ensure invertibility (hence decryption), according to an exemplary embodiment. In particular, the length of the output should be the same as the length of the input (the picture on the right has S-boxes with 4 input and 4 output bits), which is different from S-boxes in general that could also change the length, as in DES (Data Encryption Standard), for example. An S-box is usually not simply a permutation of the bits, according to an exemplary embodiment. Rather, a good S-box will have the property that changing one input bit will change about half of the output bits (or an avalanche effect), according to an exemplary embodiment. It can also have the property that each output bit can depend on every input bit, according to an exemplary embodiment.

A P-box is a permutation of all the bits, according to an exemplary embodiment: it takes the outputs of all the S-boxes of one round, permutes the bits, and feeds them into the S-boxes of the next round, according to an exemplary embodiment. A good P-box has the property that the output bits of any S-box are distributed to as many S-box inputs as possible, according to an exemplary embodiment.

At each round, the round key (obtained from the key with some simple operations, for instance, using S-boxes and P-boxes) can be combined using some group operation, typically XOR, according to an exemplary embodiment.

A single typical S-box or a single P-box alone does not have much cryptographic strength: an S-box could be thought of as a substitution cipher, according to an exemplary embodiment, while a P-box could be thought of as a transposition cipher, according to an exemplary embodiment. However, a well-designed SP network with several alternating rounds of S- and P-boxes already can satisfy Shannon's confusion and diffusion properties:

The reason for diffusion is the following: If one changes one bit of the plaintext, then it can be fed into an S-box, whose output will change at several bits, then all these changes are distributed by the P-box among several S-boxes, hence the outputs of all of these S-boxes are again changed at several bits, and so on. Doing several rounds, each bit can change several times back and forth, therefore, by the end, the ciphertext can have changed completely, in a pseudorandom manner, according to an exemplary embodiment. In particular, for a randomly chosen input block, if one flips the i-th bit, then the probability that the j-th output bit can change is approximately a half, for any i and j, which is the Strict Avalanche Criterion, according to an exemplary embodiment. Vice versa, if one changes one bit of the ciphertext, then attempts to decrypt it, the result is a message completely different from the original plaintext—SP ciphers are not easily malleable, according to an exemplary embodiment.

The reason for confusion is exactly the same as for diffusion: changing one bit of the key changes several of the round keys, and every change in every round key diffuses over all the bits, changing the ciphertext in a very complex manner, according to an exemplary embodiment.

Even if an attacker somehow obtains one plaintext corresponding to one ciphertext—a known-plaintext attack, or worse, a chosen plaintext or chosen-ciphertext attack—the confusion and diffusion make it difficult for the attacker to recover the key, according to an exemplary embodiment.

Although a Feistel network that uses S-boxes (such as DES) is quite similar to SP networks, there are some differences that make either this or that more applicable in certain situations. For a given amount of confusion and diffusion, an SP network has more “inherent parallelism” and so—given a CPU with a large number of execution units—can be computed faster than a Feistel network, according to an exemplary embodiment. CPUs with few execution units—such as most smart cards—cannot take advantage of this inherent parallelism, according to an exemplary embodiment. Also SP ciphers require S-boxes to be invertible (to perform decryption); Feistel inner functions have no such restriction and can be constructed as one-way functions, according to an exemplary embodiment.

### Exemplary Encryption/Decryption Features

Exemplary embodiments of the disclosure may include electronic transmission of, e.g., deliverables and/or electronic data files, to computing devices of clients using a variety of methods, according to an exemplary embodiment.

### Exemplary Electronic Delivery Via a Secure File Transfer Protocol (FTP)

Exemplary embodiments of the claims of this disclosure can support electronic transmission via any of various electronic protocols, preferably secure versions, including, e.g., but not limited to, file transfer protocol (FTP), FTP over SSH (SFTP), and/or FTP secured with SSL/TLS (FTPS) protocols for file transfers. FTP transmissions are conventionally not encrypted and rely solely on authentication of an FTP account for security. SFTP and FTPS are both encrypted but use different encryption methodologies. SFTP uses SSH File Transfer Protocol to encrypt the transmission. FTPS uses is FTP over secure socket layer (SSL). The files are either “delivered,” “retrieved,” or using FTP terminology, one either PUTS the files on a client's FTP system, or the client GETS the file from an FTP. FTP is a standard network protocol used to transfer computer files between a client and server on a computer network.

FTP is built on a client-server model architecture and uses separate control and data connections between the client and the server. FTP users may authenticate themselves with a clear-text sign-in protocol, normally in the form of a username and password, but can connect anonymously if the server is configured to allow it. For secure transmission that protects the username and password, and encrypts the content, FTP is often secured with SSL/TLS (FTPS). SSH File Transfer Protocol (SFTP) is sometimes also used instead, but is technologically different.

The first FTP client applications were command-line programs developed before operating systems had graphical user interfaces, and are still shipped with most Windows, Unix, and Linux operating systems. Many FTP clients and automation utilities have since been developed for desktops, servers, mobile devices, and hardware, and FTP has been incorporated into productivity applications, such as web page editors.

### Security

FTP was not designed to be a secure protocol, and has many security weaknesses. In May 1999, authors of RFC 2577 listed a vulnerability to the following problems, including, e.g., Brute force attack, FTP bounce attack, Packet capture, Port stealing, Spoofing attack, and Username protection, etc.

FTP does not encrypt its traffic; all transmissions are in clear text, and usernames, passwords, commands and data can be read by anyone able to perform packet capture (sniffing) on the network. This problem is common to many of the Internet Protocol specifications (such as SMTP, Telnet, POP and IMAP) that were designed prior to the creation of encryption mechanisms such as TLS or SSL.

Solutions to this problem include: 1) using a secure version of the insecure protocols, e.g., FTPS instead of FTP, and TelnetS instead of Telnet; 2) using a different, more secure protocol that can handle the job, e.g., SSH File Transfer Protocol or Secure Copy Protocol; and/or using a secure tunnel such as Secure Shell (SSH) or virtual private network (VPN).

FTP over SSH

FTP over SSH is the practice of tunneling a normal FTP session over a Secure Shell connection. Because FTP uses multiple TCP connections (unusual for a TCP/IP protocol that is still in use), it is particularly difficult to tunnel over SSH. With many SSH clients, attempting to set up a tunnel for the control channel (the initial client-to-server connection on port 21) will protect only that channel; when data is transferred, the FTP software at either end sets up new TCP connections (data channels) and thus have no confidentiality or integrity protection.

Otherwise, it is necessary for the SSH client software to have specific knowledge of the FTP protocol, to monitor and rewrite FTP control channel messages and autonomously open new packet forwardings for FTP data channels. Software packages that support this mode include:

### FTPS

Explicit FTPS is an extension to the FTP standard that allows clients to request FTP sessions to be encrypted, according to an exemplary embodiment. This is done by sending the “AUTH TLS” command. The server has the option of allowing or denying connections that do not request TLS. This protocol extension is defined in RFC 4217. Implicit FTPS is an outdated standard for FTP that required the use of a SSL or TLS connection. It was specified to use different ports than plain FTP.

### SSH File Transfer Protocol

The SSH file transfer protocol (chronologically the second of the two protocols abbreviated SFTP) transfers files and has a similar command set for users, but uses the Secure Shell protocol (SSH) to transfer files, according to an exemplary embodiment. Unlike FTP, SSH FTP encrypts both commands and data, preventing passwords and sensitive information from being transmitted openly over the network, according to an exemplary embodiment. SSH FTP cannot interoperate with FTP software, according to an exemplary embodiment.

### Simple File Transfer Protocol

Simple File Transfer Protocol (the first protocol abbreviated SFTP), as defined by RFC 913, was proposed as an (unsecured) file transfer protocol with a level of complexity intermediate between TFTP and FTP, according to an exemplary embodiment. Simple FTP was never widely accepted on the Internet, and is now assigned Historic status by the IETF. It runs through port 115, and often receives the initialism of SFTP. It has a command set of 11 commands and support three types of data transmission: ASCII, binary and continuous. For systems with a word size that is a multiple of 8 bits, the implementation of binary and continuous is the same, according to an exemplary embodiment. The protocol also supports login with user ID and password, hierarchical folders and file management (including rename, delete, upload, download, download with overwrite, and download with append), according to an exemplary embodiment.

### Delivery Via Encrypted Email Using TLS Encryption

An exemplary embodiment can use the Smarsh Secure Email service. Smarsh, according to an exemplary embodiment, is one of the hops in an email delivery path. All outbound emails can be made to flow through Smarsh's systems, or an alike system, according to an exemplary embodiment. The Smarsh system can include, according to an exemplary embodiment, an interface for RA to adjust a policy filter that can determine which emails are encrypted. There can be a variety of policies that can be set but rather than give all the details on the types of policies, two examples can be provided, according to an exemplary embodiment; 1. a policy that forces all emails with the text “[SECURE]” at the beginning of the subject line will be delivered securely, 2. a policy that forces all emails with an attachment of a certain file type (e.g. .pdf) or file mask (e.g. trades*.xls) are delivered securely. In the first example, the sender of the email can control whether is has been sent securely by inserting the word “[SECURE]” in the subject line. In the second example, an exemplary IT can force all emails, and/or electronic transmissions, with a certain file mask to be sent securely, according to an exemplary embodiment. According to an exemplary embodiment, a first method can be sometimes preferred to be used, because the portfolio construction team can send other emails to the same clients which don't travel securely. The systems can be set up to provide for securing any communications and/or emails that contain the delivery of data representative of or indicative of portfolios, indexes, etc. According to another exemplary embodiment, a computer software based graphical user interface can be provided, that can restrict access to the exemplary proprietary electronic data, via any of various encryption/decryption/cryptographic technologies, as noted, for example, herein.

After the emails hit the Smarsh system, according to an exemplary embodiment, Smarsh can try to deliver the emails to the recipient's email server using TLS (Transport Layer Security). With TLS, a secure channel can be established between the Smarsh and the recipient's email server and the transmission can be encrypted, according to an exemplary embodiment. Not all recipient email servers may accept a TLS connection (for a variety of reasons) so there is a second option in that scenario, according to an exemplary embodiment. If Smarsh can't establish a TLS connection, according to an exemplary embodiment then the system can send an email to the recipient notifying the recipient that the recipient has a Secure Email waiting for them on the Smarsh Portal, according to an exemplary embodiment. This notification is not encrypted, according to an exemplary embodiment, but the subsequent retrieval is encrypted because the recipient logs into the Smarsh portal (after setting up a password protected account for first time users) and can retrieve the file via SSL, according to an exemplary embodiment.

In summary, TLS can be attempted first but if it fails then SSL delivery can be through a portal, providing an exemplary 100% guaranteed secure delivery.

The only other thing to add to the conversation is that an exemplary IT department can do a forced TLS connection directly to a client's email server, according to an exemplary embodiment. Two email servers, according to an exemplary embodiment, can only communicate if a TLS connection is established, according to an exemplary embodiment. If the servers cannot establish a TLS connection, then no emails are sent.

Delivery via secure portal in the event TLS encryption is not engaged or used by the recipient, can thus be accomplished, as noted above, according to an exemplary embodiment.

### Exemplary Electronic Index Calculator Data Controller

In one embodiment, an electronic data controller (not shown) as can be part of computer system 600 may be connected to, or coupled to, and/or communicate with entities such as, e.g., but not limited to: one or more users from user input device(s); user output device(s); peripheral devices; an optional cryptographic processor device; and/or a communications network. In certain exemplary embodiments, to protect the proprietary nature of electronic data indicative of a financial index, such electronic data can be encrypted, and/or decrypted by any of various exemplary cryptographic methods. In some embodiments the encryption/decryption system can be software implemented; in other embodiments the encryption/decryption system can be hardware implemented, and/or implemented in a combination of hardware and/or software.

Depending on the particular implementation, features of the controller system may be achieved by implementing a hardware controller or microcontroller such as, e.g., but not limited to, a Xilinx Inc. UG388 FPGA Memory controller; CAST, Inc. R8051XC2 microcontroller; Intel Corp. MCS 51 (i.e., 8051 microcontroller); and/or the like. The controller can be used to encode and/or decode, encrypt and/or decrypt data, such as, e.g., but not limited to, index constituent and/or weighting data and/or other data regarding financial securities, and/or asset allocation. Also, to implement certain features of exemplary embodiments of the claimed system, some feature implementations may rely on embedded components, such as, e.g., but not limited to: Application-Specific Integrated Circuit (“ASIC”), Digital Signal Processing (“DSP”), Field Programmable Gate Array (“FPGA”), and/or the like embedded technology. For example, any of the claimed system components (distributed and/or otherwise) and/or features may be implemented via the microprocessor and/or via embedded components; e.g., via ASIC, coprocessor, DSP, FPGA, and/or the like. Alternately, some implementations of the controller system may be implemented with embedded components that are configured and used to achieve a variety of features and/or signal processing.

Depending on the particular implementation, the embedded components may include, e.g., but are not limited to, software solutions, hardware solutions, and/or some combination of both hardware/software solutions. For example, controller system features discussed herein may be achieved through implementing FPGAs, which can be a semiconductor devices containing programmable logic components called “logic blocks,” and programmable interconnects, such as the high performance FPGA Virtex series and/or the low cost Spartan and/or other series manufactured by Xilinx. Logic blocks and/or interconnects can be programmed by the customer or designer, after the FPGA is manufactured, to implement any of the features. A hierarchy of programmable interconnects can allow logic blocks to be interconnected as needed by the system designer/administrator, somewhat like a one-chip programmable breadboard. An FPGAs logic blocks can be programmed to perform the operation of basic logic gates such as AND, and XOR, or more complex combinational operators such as decoders or mathematical operations. In most FPGAs, the logic blocks can also include, e.g., but not limited to, memory elements, which may be circuit flip-flops and/or more complete blocks of memory. In some circumstances, the system may be developed on regular FPGAs and then migrated into a fixed version that can more resemble an ASIC implementation. Alternate or coordinating implementations may migrate controller features to a final ASIC instead of, and/or in addition to, FPGAs. Depending on the implementation all of the aforementioned embedded components and microprocessors may be considered the “CPU” and/or “processor” for the controller system.

### Exemplary Power Source

A power source may be provided, including, e.g., any of various standard form sources, which can be used for powering small electronic circuit board devices such as, e.g., but not limited to, the following power battery cells: alkaline, lithium hydride, lithium ion, lithium polymer, nickel cadmium, solar cells, and/or the like. Other types of AC or DC power sources may be used as well. In the case of solar cells, in one exemplary embodiment, a case can provide an aperture through which the solar cell may capture photonic energy. The power cell can be connected and/or coupled to at least one of the interconnected subsequent components of the device thereby providing an electric current to all subsequent components. In one example, the power source is connected and/or coupled to the system bus component. In an alternative embodiment, an outside power source is provided through a connection across the I/O interface. For example, a USB and/or IEEE 1394 connection carries both data and power across the connection and is therefore a suitable source of power.

Peripheral devices may be connected and/or communicate to, e.g., I/O and/or other facilities of the like such as, e.g., but not limited to, network interfaces, storage interfaces, directly to the interface bus, system bus, the CPU, and/or the like. Peripheral devices may be external, internal and/or part of the controller. Peripheral devices may include, e.g., but not limited to: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto (encryption/decryption) devices), force-feedback devices (e.g., vibrating motors), network interfaces, printers, scanners, storage devices, transceivers (e.g., cellular, GPS, etc.), video devices (e.g., goggles, monitors, etc.), video sources, visors, touch screens, multi-touch screens, sensor(s), biometric system(s) (e.g., fingerprint, retinal scan, iris scan, voice recognition, scanners and/or recognition systems, etc.), pattern recognition system, image recognition system, and/or the like. Peripheral devices often include types of input devices and/or sensors (e.g., cameras, proximity sensors, gyroscopic sensors, location sensing, touch sensor, ultrasonic sensor, accelerometer sensor, altimeter, GPS, etc.).

It should be noted that although user input devices and peripheral devices may be employed, the controller may be embodied as an embedded, dedicated, and/or monitor-less (i.e., headless) device, wherein access could be provided over, e.g., a network interface connection.

Cryptographic units such as, e.g., but not limited to, microcontrollers, processors, interfaces, and/or devices may be attached, and/or communicate with the controller. A MC68HC16 microcontroller, manufactured by Motorola Inc., can be used in one embodiment, for and/or within cryptographic units. The MC68HC16 microcontroller can use an exemplary 16-bit multiply-and-accumulate instruction in the 16 MHz configuration and can require less than one second to perform a 512-bit RSA private key operation. Cryptographic units can support authentication of communications from interacting agents, and/or authorized access to encrypted data, etc., as well as allowing for anonymous transactions. Cryptographic units may also be configured as part of the CPU. Equivalent microcontrollers and/or computer processors may also be used in alternative embodiments. Other commercially available specialized cryptographic processors include: SafeNet's Luna PCI (e.g., 7100) series; Broadcom's CryptoNetX and other Security Processors; nCipher's nShield; Sun's Cryptographic Accelerators (e.g., Accelerator 6000 PCIe Board, Accelerator 500 Daughtercard); Semaphore Communications' 40 MHz Roadrunner 184; Via Nano Processor (e.g., L2100, L2200, U2400) line, which can in certain embodiments, e.g., be capable of performing 500+MB/s of cryptographic instructions; VLSI Technology's 33 MHz 6868; and/or the like.

### Exemplary Cryptographic Server

An exemplary cryptographic server component can be a stored program component that can be executed by a CPU, cryptographic processor, cryptographic processor interface, cryptographic processor device, and/or the like. Exemplary cryptographic processor interfaces can allow for expedition of encryption and/or decryption requests by the cryptographic component; however, the cryptographic component, alternatively, may run on a conventional CPU. The cryptographic component, can allow for the encryption and/or decryption of provided data. The cryptographic component can allow for both symmetric and/or asymmetric (e.g., Pretty Good Protection (PGP)) encryption and/or decryption. The cryptographic component can employ cryptographic techniques such as, e.g., but not limited to: digital certificates (e.g., X.509 authentication framework), digital signatures, dual signatures, enveloping, password access protection, public key management, and/or the like. The cryptographic component can facilitate numerous (encryption and/or decryption) security protocols such as, e.g., but not limited to: checksum, Advanced Encryption Standard (AES), Data Encryption Standard (DES), Elliptical Curve Encryption (ECC), International Data Encryption Algorithm (IDEA), Message Digest 5 (MDS, which is a one way hash operation), passwords, Rivest Cipher (RCS), Rijndael, RSA (which is an asymmetric, Internet encryption and authentication system that uses an algorithm developed in 1977 by Ron Rivest, Adi Shamir, and Leonard Adleman, also known as public key cryptography, because one key can be given to everyone), Secure Hash Algorithm (SHA), Secure Socket Layer (SSL), Secure Hypertext Transfer Protocol (HTTPS), and/or the like. Employing such encryption security protocols, the system, in certain embodiments, may encrypt all incoming and/or outgoing communications and may serve as a node, e.g., within a virtual private network (VPN) with a wider communications network. The cryptographic component can facilitate a process of “security authorization” whereby access to a resource can be inhibited by a security protocol wherein the cryptographic component can effect authorized access to the secured resource. In addition, the cryptographic component can provide a unique identifier(s) of content, e.g., employing and/or MD5 hash to obtain a unique signature for, e.g., but not limited to, a data file storing proprietary data such as, e.g., a financial index components and/or constituents, and/or weightings; a digital audio file, a video file, etc. A cryptographic component may communicate to and/or with other components in a component collection, including, e.g., itself, a computer graphical user interface, i/o devices, biometric sensors, and/or other sensors, a computer database, and/or facilities, or the like. The cryptographic component can support encryption schemes allowing for the secure transmission of information across, e.g., a communications network to enable the component to engage in secure transactions if so desired. The cryptographic component can facilitate the secure accessing of resources and/or can facilitate the access to, or of, secured resources on remote and/or networked systems and/or via secure means; i.e., it may act as a client and/or server of secured resources. Most frequently, the cryptographic component can communicate with information servers, operating systems, other program components, and/or the like. The cryptographic component may contain, communicate, generate, obtain, and/or provide program component, system, user, and/or data communications, requests, and/or responses.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. An automated computer implemented method comprising:
receiving electronically, by at least one special purpose computer index calculator computer device computer processor, a universe of publicly traded companies;
receiving electronically, by the at least one special purpose computer index calculator computer device computer processor, from an electronic data source a plurality of metrics relating to the publicly traded companies, comprising:
corporate action data,
price data,
foreign exchange data, and
fundamental financial metric data;
combining electronically, by the at least one special purpose computer index calculator computer device computer processor, said plurality of metrics to calculate:
a robustness ranking;
a dividend yield percentile ranking; and
a noncapitalization weighting for the publicly traded companies
using, by the at least one special purpose computer index calculator computer device computer processor, said combined metric data to at least one of:
a) electronically selecting or weighting, by the at least one special purpose computer index calculator computer device computer processor, constituents of an index based on said combined data;
b) electronically selecting or weighting, by the at least one special purpose computer index calculator computer device computer processor, a portfolio of financial objects based on said combined data; or
c) electronically allocating, by the at least one special purpose computer index calculator computer device computer processor, assets in a portfolio based on said combined data.

2. The automated computer implemented method according to claim 1, wherein said receiving comprises:
receiving said plurality of metrics, wherein at least one of said plurality of metrics comprises a non-price metric.

3. The automated computer implemented method according to claim 1, wherein said combining to calculate a robustness ranking comprises:
electronically calculating, by at least one computer processor, a ratio of income before extraordinary items to the book value of assets;
electronically calculating, by at least one computer processor, a ratio of cash flow to short term debt plus interest expenses; and
electronically calculating, by at least one computer processor, a net operating accruals cumulative difference between operating income and cash flow scaled by total assets.

4. The automated computer implemented method according to claim 1, wherein said combining to calculate a robustness ranking comprises at least one of:
electronically calculating, by at least one computer processor, a ratio of income before extraordinary items to the book value of assets;
electronically calculating, by at least one computer processor, a ratio of cash flow to short term debt plus interest expenses; or
electronically calculating, by at least one computer processor, a net operating accruals cumulative difference between operating income and cash flow scaled by total assets.

5. The automated computer implemented method according to claim 1, further comprising:
electronically determining, by at least one computer processor, a fundamental equity income weight for each constituent of said universe.

6. The automated computer implemented method according to claim 1, further comprising:
electronically screening, by the at least one special purpose computer index calculator computer device computer processor, said universe based on dividend yield and financial health.

7. The automated computer implemented method according to claim 6, wherein said financial health is determined by analyzing, by the at least one special purpose computer index calculator computer device computer processor, said robustness measures.

8. The automated computer implemented method according to claim 1, further comprising:
electronically banding, by the at least one special purpose computer index calculator computer device computer processor, to prevent excessive portfolio turnover.

9. The automated computer implemented method according to claim 8, wherein said electronically banding comprises increasing weighting by 20% to current constituents.

10. The automated computer implemented method according to claim 1, further comprising:
electronically applying, by the at least one special purpose computer index calculator computer device computer processor, liquidity constraints or limits to ensure sufficient liquidity volume to support inclusion by using a liquidity ratio of fundamental weight to liquidity weight.

11. The automated computer implemented method according to claim 1, wherein said combining electronically said dividend yield percentile ranking comprises a trailing twelve month dividends per share divided by stock price as of the data cut-off date, and yield rank comprises a percentile rank by dividend yield within relevant region or country ICB industry.

12. The automated computer implemented method according to claim 1, wherein said method is executed on a special purpose computer electronically coupled to an electronic analysis host computer, and electronically coupled to an electronic trading host computer via an electronic and/or optical networking communications system providing realtime access to data of said electronic data source.

13. An automated computer data processing system comprising:
at least one special purpose computer processor; and
at least one memory coupled to said special purpose computer processor, said computer processor configured to:
receive electronically, by at least one special purpose computer index calculator computer device computer processor, a universe of publicly traded companies;
receive electronically, by the at least one special purpose computer index calculator computer device computer processor, from an electronic data source a plurality of metrics relating to the publicly traded companies, comprising:
corporate action data,
price data,
foreign exchange data, and
fundamental financial metric data;
combine electronically, by the at least one special purpose computer index calculator computer device computer processor, said plurality of metrics to calculate:
a robustness ranking;
a dividend yield percentile ranking; and
a noncapitalization weighting for the publicly traded companies
use, by the at least one special purpose computer index calculator computer device computer processor, said combined metric data to at least one of:
a) electronically select or weight, by the at least one special purpose computer index calculator computer device computer processor, constituents of an index based on said combined data;
b) electronically select or weight, by the at least one special purpose computer index calculator computer device computer processor, a portfolio of financial objects based on said combined data; or
c) electronically allocate, by the at least one special purpose computer index calculator computer device computer processor, assets in a portfolio based on said combined data.

14. The automated computer implemented method according to claim 1, further comprising:
electronically creating, by at least one computer processor, at least one of:
at least one electronic index data indicative of at least one non-price index based on a plurality of non-price metrics, or
at least one electronic decision support asset allocation recommendation based on a plurality of non-price metrics,
wherein said electronically creating comprises:
electronically selecting, by the at least one computer processor, electronic universe data indicative of a universe of financial objects at an analysis host computing device, wherein said electronically selecting comprises:
electronically receiving, by the at least one computer processor, a plurality of entity data, and a plurality of financial object data of said universe of financial objects from at least one electronic data source,
transforming, by the at least one computer processor, said plurality of entity data and said plurality of financial object data of said universe of financial objects into a universe object model, wherein said transforming said universe object model comprises:
partitioning, by the at least one computer processor, said plurality of entity data, and said plurality of financial object data of said universe into partitioned universe data, and
enabling, by the at least one computer processor, a plurality of attributes of said electronic universe data to be electronically selectable; and
providing, by the at least one computer processor, at least one application programming interface (API) to allow manipulating said partitioned universe data of said universe object model via said plurality of attributes,
electronically receiving, by the at least one computer processor, electronic non-price data indicative of a plurality of said non-price metrics about said electronic universe data indicative of said universe of financial objects from the at least one electronic data source, at the analysis host computing device via the entity data of an entity database from the at least one electronic data source,
electronically manipulating said universe data comprising at least one of:
providing, by the at least one computer processor, an electronic decision support system comprising:
receiving, by the at least one computer processor, instructions from a user;
manipulating, by the at least one computer processor, based on said instructions and said electronic non-price data, said partitioned universe data of said universe object model, using said APIs and said plurality of attributes; and
at least one of:
providing, by the at least one computer processor, based on said electronic non-price data, at least one asset allocation recommendation; or
electronically transforming, by the at least one computer processor, via an index generation subsystem, said electronic non-price data indicative of said plurality of said non-price metrics about said universe of financial objects into said electronic index data indicative of said non-price index based on said non-price metrics, at the analysis host computing device, said electronically transforming comprising:
electronically selecting, by the at least one computer processor, electronic subset data indicative of a subset of said financial objects of said universe based on at least one of said non-price metrics; and
electronically weighting, by the at least one computer processor, said electronic subset data indicative of said subset of said universe according to at least one of said non-price metrics to obtain the electronic index data indicative of the non-price index of weighted financial objects; and
electronically creating, by the at least one computer processor, electronic index portfolio data indicative of a portfolio of financial objects using the non-price index, including said subset of selected and weighted financial objects; and
electronically outputting, by the at least one computer processor, at least one of:
said asset allocation recommendations based on the non-price metrics;
the electronic index data indicative of the non-price index created based on the non-price metrics; or
the electronic index portfolio data indicative of the portfolio of financial objects created based on the non-price index.
